(19) United States
(12) Patent Application Publication
(10) Pub. No.: US 2026/0056361 A1
(43) Pub. Date: Feb. 26, 2026

(54) PHOTONIC INTEGRATED CIRCUIT AND METHODS OF FORMATION

(71) Applicant: Taiwan Semiconductor Manufacturing Company, Ltd., Hsinchu (TW)

(72) Inventors: Wen-Shun LO, Zhudong Township (TW); Tsung-Lin HSIEH, Hsinchu City (TW); Chun-Heng CHEN, Hsinchu City (TW); Shao-Da WANG, New Taipei City (TW); Sheng Kai YEH, Taichung City (TW); Chi-Yuan SHIH, Hsinchu (TW); YingKit Felix TSUI, Cupertino, CA (US)

(21) Appl. No.: 18/809,815

(22) Filed: Aug. 20, 2024

(51) Int. Cl. G02B 6/122; G02B 6/12; G02B 6/136

(52) U.S. Cl. CPC G02B 6/1228; G02B 6/136; G02B 2006/12097

(57) ABSTRACT

A plurality of optical waveguide structures are formed in a semiconductor layer of a semiconductor photonics device in a manner in which different physical dimensions and/or configurations can be realized for the optical waveguide structures. For example, the operations described herein enable strip waveguide structures and rib waveguide structures to be formed from the same semiconductor layer and in the same process flow. Additionally and/or alternatively, rib waveguide structures having different slab thicknesses, different ridge thicknesses, and/or different combinations of slab thicknesses and ridge thicknesses may be formed from the same semiconductor layer and in the same process flow. This enables the functions performed by the optical waveguide structures to be optimized to achieve low insertion loss in the semiconductor photonics device, to achieve a high modulation efficiency in the semiconductor photonics device, and/or to achieve lower power consumption in the semiconductor photonics device, among other examples.

### BACKGROUND

A semiconductor photonics device may be configured to use optical signals for high speed and secure data transmission between integrated circuits and/or semiconductor dies of the semiconductor photonics device. An optical signal may be transferred through a waveguide in the semiconductor photonics device. The waveguide enables confinement of the optical signal, which may reduce optical loss and increase propagation efficiency for the optical signal. Data may be encoded into an optical signal by modulating light into optical pulses through an optical modulator. The optical pulses are then transferred to the waveguide for propagation to other regions of the semiconductor photonics device.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1A and 1B are diagrams of an example semiconductor photonics device described herein.

FIGS. 2A-2Q are diagrams of an example implementation of forming a semiconductor photonics device described herein.

FIGS. 3A and 3B are diagrams of an example semiconductor photonics device described herein.

FIGS. 4A and 4B are diagrams of an example semiconductor photonics device described herein.

FIGS. 5A and 5B are diagrams of an example semiconductor photonics device described herein.

FIGS. 6A-6N are diagrams of an example implementation of forming a semiconductor photonics device described herein.

FIG. 7 is a flowchart of an example process associated with forming a photonic integrated circuit of a semiconductor photonics device described herein.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

A plurality of optical waveguide structures may be formed in a semiconductor photonics device to perform various functions. Some optical waveguide structures may be configured to facilitate propagation of optical signals throughout a photonic integrated circuit. Some optical waveguide structures may be included in an optical modulator structure and configured to modulate optical signals. Some optical waveguide structures may be configured as an optical splitter that is configured to split an optical signal into a plurality of optical signals. Some optical waveguide structures may be included in a photodetector structure and configured to generate an electrical current based on received optical signals.

The optical waveguide structures may be formed from a semiconductor layer of the semiconductor photonics device. While forming a plurality of optical waveguide structures in a semiconductor photonics device may enable the manufacturing processes for the optical waveguide structures to be integrated together, and may enable various types of photonic integrated circuits to be realized in the semiconductor photonics device, forming the optical waveguide structures to have the same physical dimensions and configurations may result in some of the functions performed by the optical waveguide structures suffering from insertion loss, reduced modulation efficiency, and/or increased power consumption.

In some implementations described herein, a plurality of optical waveguide structures are formed in a semiconductor layer of a semiconductor photonics device. The optical waveguide structures are formed in a manner in which different physical dimensions and/or configurations can be realized for the optical waveguide structures. For example, the operations described herein enable strip waveguide structures and rib waveguide structures to be formed from the same semiconductor layer and in the same process flow. Additionally and/or alternatively, the operations described herein enable rib waveguide structures having different slab thicknesses, different ridge thicknesses, and/or different combinations of slab thicknesses and ridge thicknesses to be formed from the same semiconductor layer and in the same process flow. This enables the functions performed by the optical waveguide structures to be optimized to achieve low insertion loss in the semiconductor photonics device, to achieve a high modulation efficiency in the semiconductor photonics device, and/or to achieve lower power consumption in the semiconductor photonics device, among other examples.

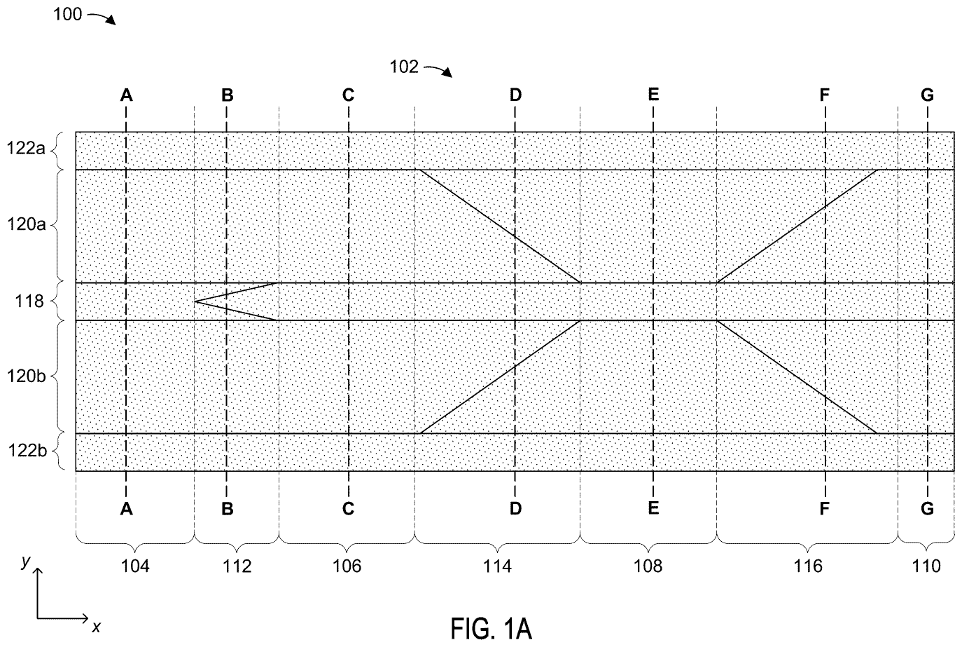

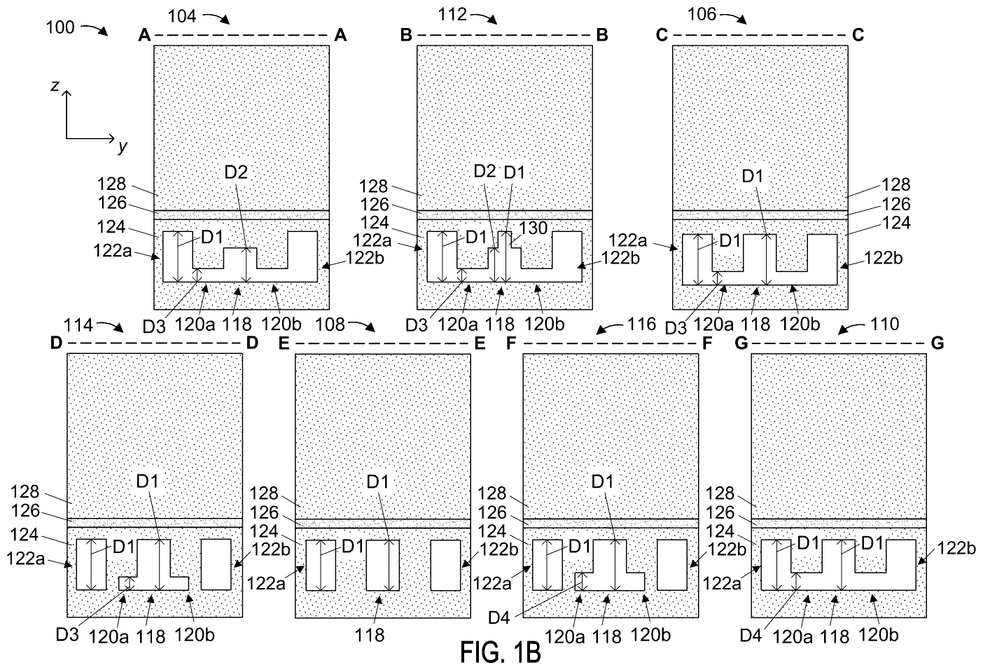

FIGS. 1A and 1B are diagrams of an example semiconductor photonics device 100 described herein. FIG. 1A illustrates a top-down view of an x-y plane of the semiconductor photonics device 100. As shown in FIG. 1A, the semiconductor photonics device 100 is a semiconductor device that includes a photonic integrated circuit 102. The photonic integrated circuit 102 may include various semiconductor photonic components, such as a rib optical waveguide structure 104, a rib optical waveguide structure 106, a strip optical waveguide structure 108, and/or a rib optical waveguide structure 110, among other examples.

In some implementations, two or more of the rib optical waveguide structure 104, the rib optical waveguide structure 106, the strip optical waveguide structure 108, and/or the rib optical waveguide structure 110 may be formed from a same semiconductor layer of the semiconductor photonics device 100. In these implementations, transition region(s) may be included between the two or more of the rib optical waveguide structure 104, the rib optical waveguide structure 106, the strip optical waveguide structure 108, and/or the rib optical waveguide structure 110.

For example, the rib optical waveguide structure 104 and the rib optical waveguide structure 106 may be formed from the same semiconductor layer, and a transition region 112 may be included laterally between (e.g., in the x-direction) the rib optical waveguide structure 104 and the rib optical waveguide structure 106. In the transition region 112, the arrangement, shapes, and/or dimensions of structures in the semiconductor may transition between the rib optical waveguide structure 104 and the rib optical waveguide structure 106.

As another example, the rib optical waveguide structure 106 and the strip optical waveguide structure 108 may be formed from the same semiconductor layer, and a transition region 114 may be included laterally between (e.g., in the x-direction) the rib optical waveguide structure 106 and the strip optical waveguide structure 108. In the transition region 114, the arrangement, shapes, and/or dimensions of structures in the semiconductor may transition between the rib optical waveguide structure 106 and the strip optical waveguide structure 108.

As another example, the strip optical waveguide structure 108 and the rib optical waveguide structure 110 may be formed from the same semiconductor layer, and a transition region 116 may be included laterally between (e.g., in the x-direction) the strip optical waveguide structure 108 and the rib optical waveguide structure 110. In the transition region 116, the arrangement, shapes, and/or dimensions of structures in the semiconductor may transition between the strip optical waveguide structure 108 and the rib optical waveguide structure 110.

As further shown in FIG. 1A, each of the rib optical waveguide structure 104, the rib optical waveguide structure 106, the strip optical waveguide structure 108, and the rib optical waveguide structure 110 includes a ridge section 118. The ridge section 118 (which is sometimes referred to as a core section or a rib section) may continuously extend in an x-direction in the semiconductor photonics device 100 between two or more of the rib optical waveguide structure 104, the rib optical waveguide structure 106, the strip optical waveguide structure 108, and/or the rib optical waveguide structure 110.

As further shown in FIG. 1A, the rib optical waveguide structure 104, the rib optical waveguide structure 106, and the rib optical waveguide structure 110 each include slab sections 120a and 120b on opposing sides of the ridge section 118 in a y-direction in the semiconductor photonics device 100. Thus, the rib optical waveguide structure 104, the rib optical waveguide structure 106, and the rib optical waveguide structure 110 each include a combination of slab sections 120a and 120b and a ridge section 118. The slab sections 120a and 120b may extend in the x-direction. The strip optical waveguide structure 108, however, only includes a ridge section 118, and the slab sections 120a and 120b are omitted from the strip optical waveguide structure 108. The slab sections 120a and 120b in the transition regions 114 and 116 are tapered in the y-direction along the x-direction as a result. In other words, the y-direction lateral width of the slab sections 120a and 120b changes along the x-direction in the transition regions 114 and 116.

As further shown in FIG. 1A, the rib optical waveguide structure 104, the rib optical waveguide structure 106, the strip optical waveguide structure 108, and the rib optical waveguide structure 110 may each include terminal sections 122a and 122b on opposing sides of the ridge section 118 in the y-direction. The terminal sections 122a and 122b may extend in the x-direction. In some implementations, the terminal section 122a may be coupled to the slab section 120a, and the terminal sections 122b may be coupled to the slab section 120b. The terminal sections 122a and 122b may be sections of the photonic integrated circuit 102 in which electrical connections may be provided for the rib optical waveguide structure 104, the rib optical waveguide structure 106, and/or the rib optical waveguide structure 110.

FIG. 1B illustrates cross-sectional views of the semiconductor photonics device 100 in the y-direction, such as a cross-sectional view of the semiconductor photonics device 100 along the line A-A in FIG. 1A, a cross-sectional view of the semiconductor photonics device 100 along the line B-B in FIG. 1A, a cross-sectional view of the semiconductor photonics device 100 along the line C-C in FIG. 1A, a cross-sectional view of the semiconductor photonics device 100 along the line D-D in FIG. 1A, a cross-sectional view of the semiconductor photonics device 100 along the line E-E in FIG. 1A, a cross-sectional view of the semiconductor photonics device 100 along the line F-F in FIG. 1A, and a cross-sectional view of the semiconductor photonics device 100 along the line G-G in FIG. 1A. The cross-sectional view along the line A-A is a cross-sectional view of the rib optical waveguide structure 104. The cross-sectional view along the line B-B is a cross-sectional view of the transition region 112. The cross-sectional view along the line C-C is a cross-sectional view of the rib optical waveguide structure 106. The cross-sectional view along the line D-D is a cross-sectional view of the transition region 114. The cross-sectional view along the line E-E is a cross-sectional view of the strip optical waveguide structure 108. The cross-sectional view along the line F-F is a cross-sectional view of the transition region 116. The cross-sectional view along the line G-G is a cross-sectional view of the rib optical waveguide structure 110.

As shown in FIG. 1B, the rib optical waveguide structure 104, the rib optical waveguide structure 106, the strip optical waveguide structure 108, and/or the rib optical waveguide structure 110 may be included in a dielectric region 124. An etch stop layer 126 may be included above the dielectric region 124, and another dielectric region 128 may be included above the etch stop layer 126. The dielectric region 124, the etch stop layer 126, and the dielectric region 128 may each include one or more dielectric materials. Examples of such dielectric materials include an oxide (e.g., a silicon oxide (SiOₓ) and/or another oxide material), an undoped silicate glass (USG), a boron-containing silicate glass (BSG), a fluorine-containing silicate glass (FSG), an extreme low dielectric constant (ELK) dielectric material having a dielectric constant that is less than approximately 2.5, a silicon nitride (SiₓN_{y}), silicon carbide (SiC), silicon oxynitride (SiON), and/or another suitable dielectric material.

As indicated above, the rib optical waveguide structure 104, the rib optical waveguide structure 106, the strip optical waveguide structure 108, and/or the rib optical waveguide structure 110 may be formed from the same semiconductor layer of the semiconductor photonics device 100. The rib optical waveguide structure 104, the rib optical waveguide structure 106, the strip optical waveguide structure 108, and/or the rib optical waveguide structure 110 may include one or more semiconductor materials such as silicon (Si), doped silicon, germanium (Ge), silicon germanium (SiGe), a III-V semiconductor material, and/or another suitable semiconductor material. Additionally and/or alternatively, one or more of the rib optical waveguide structure 104, the rib optical waveguide structure 106, the strip optical waveguide structure 108, and/or the rib optical waveguide structure 110 may be formed from a dielectric layer and may include one or more dielectric materials described above and/or another suitable dielectric material.

As further shown in FIG. 1B, the rib optical waveguide structure 104, the rib optical waveguide structure 106, the strip optical waveguide structure 108, the rib optical waveguide structure 110, and the associated transition regions 112, 114, and 116 may each have one or more dimensions. Two or more of the rib optical waveguide structure 104, the rib optical waveguide structure 106, the strip optical waveguide structure 108, and/or the rib optical waveguide structure 110 may have different dimensions (e.g., different ridge section dimensions, different slab section dimensions), and the transition regions 112, 114, and/or 116 may provide a transition between the different dimensions of the rib optical waveguide structure 104, the rib optical waveguide structure 106, the strip optical waveguide structure 108, and/or the rib optical waveguide structure 110.

As shown in FIG. 1B, the terminal sections 122a and 122b may each have a dimension D1 corresponding to a vertical (z-direction) thickness of the terminal sections 122a and 122b. The ridge section 118 of the rib optical waveguide structure 106, the ridge section 118 of the strip optical waveguide structure 108, the ridge section 118 of the rib optical waveguide structure 110, and the ridge section 118 of the transition regions 114 and 116 may each have approximately the same vertical (z-direction) thickness as the terminal sections 122a and 122b, which corresponds to the dimension D1. In some implementations, the dimension D1 is included in a range of approximately 250 nanometers to approximately 350 nanometers. However, other values and ranges for the dimension D1 are within the scope of the present disclosure.

As further shown in FIG. 1B, the ridge section 118 of the rib optical waveguide structure 104 has a dimension D2 corresponding to a vertical (z-direction) thickness of the ridge section 118 of the rib optical waveguide structure 104. The vertical (z-direction) thickness of the ridge section 118 of the rib optical waveguide structure 104 may be less than the vertical (z-direction) thickness of the ridge section 118 of the rib optical waveguide structure 106. Similarly, the vertical (z-direction) thickness of the ridge section 118 of the rib optical waveguide structure 104 may be less than the vertical (z-direction) thickness of the ridge sections 118 of the strip optical waveguide structure 108 and the rib optical waveguide structure 110. In some implementations, the dimension D2 is included in a range of approximately 150 nanometers to approximately 250 nanometers. However, other values and ranges for the dimension D2 are within the scope of the present disclosure.

Having a lesser vertical (z-direction) thickness of the ridge section 118 of the rib optical waveguide structure 104 (e.g., D2<D1) may provide greater modulation efficiency in implementations in which the rib optical waveguide structure 104 is included in an optical modulator structure such as a micro-ring modulator (MRM) or a Mach-Zehnder modulator (MZM), among other examples. In particular, the lesser vertical (z-direction) thickness of the ridge section 118 of the rib optical waveguide structure 104 may increase the overlap between the optical modes of optical signals that propagate through the optical modulator structure and the p-n junction of the optical modulator structure (which primarily occupies the ridge section 118 of the rib optical waveguide structure 104), thereby increasing the modulation efficiency of the optical modulator structure. Having a greater vertical (z-direction) thickness of the ridge section 118 of the rib optical waveguide structure 110 (e.g., D1>D2) may provide a greater area in the ridge section 118 for formation of an absorption region in implementations in which the rib optical waveguide structure 110 is included in a photodetector structure. This may increase the full well capacity, and thus the sensitivity and range, of the photodetector structure.

In the transition region 112 between the rib optical waveguide structure 104 and the rib optical waveguide structure 106, a tapered section 130 (e.g., a tapered transition section) is provided on the ridge section 118 of the transition region 112. The lateral (y-direction) width of the tapered section 130 increases from the rib optical waveguide structure 104 to the rib optical waveguide structure 106. The taper of the tapered section 130 provides an adiabatic transition between the lesser vertical (z-direction) thickness of the ridge section 118 of the rib optical waveguide structure 104 (dimension D2) and the greater vertical (z-direction) thickness of the ridge section 118 of the rib optical waveguide structure 106 (dimension D1) with minimal to no optical loss. Thus, the vertical (z-direction) thickness of the combination of the ridge section 118 and the tapered section 130 of the transition region 112 is approximately equal to the vertical (z-direction) thickness of the ridge section 118 of the rib optical waveguide structure 106 (e.g., is approximately equal to the dimension D1).

As further shown in FIG. 1B, the slab sections 120a, 120b of the rib optical waveguide structure 104, the rib optical waveguide structure 106, the transition region 112, and the transition region 114 may each have a dimension D3 corresponding to a z-direction of the slab sections 120a, 120b. In some implementations, the dimension D3 is included in a range of approximately 30 nanometers to approximately 90 nanometers. However, other values and ranges for the dimension D3 are within the scope of the present disclosure.

As further shown in FIG. 1B, the slab sections 120a, 120b of the rib optical waveguide structure 110 and the transition region 116 may each have a dimension D4 corresponding to a z-direction of the slab sections 120a, 120b. The lesser vertical (z-direction) thickness of the slab sections 120a, 120b of the rib optical waveguide structure 104 and the rib optical waveguide structure 106 may be less than the vertical (z-direction) thickness of the slab sections 120a, 120b of the rib optical waveguide structure 110 (e.g., D3<D4). In some implementations, the dimension D4 is included in a range of approximately 50 nanometers to approximately 100 nanometers. However, other values and ranges for the dimension D4 are within the scope of the present disclosure.

Having a lesser vertical (z-direction) thickness of the slab sections 120a, 120b of the rib optical waveguide structure 104 (e.g., D3<D4) may provide greater modulation efficiency in implementations in which the rib optical waveguide structure 104 is included in an optical modulator structure. In particular, the lesser vertical (z-direction) thickness of the slab sections 120a, 120b of the rib optical waveguide structure 104 may provide greater optical confinement of optical signals to the ridge section 118 of the rib optical waveguide structure 104, which may increase the overlap between the optical mode of optical signals that propagate through the optical modulator structure and the p-n junction of the optical modulator structure, thereby increasing the modulation efficiency of the optical modulator structure. Having a greater vertical (z-direction) thickness of the slab sections 120a, 120b of the rib optical waveguide structure 110 (e.g., D4>D3) may provide a greater area in the slab sections 120a, 120b for current flow from an absorption region in implementations in which the rib optical waveguide structure 110 is included in a photodetector structure. This may reduce the electrical resistance between the absorption region and the terminal sections 122a, 122b through the slab sections 120a, 120b, which may increase the efficiency of the photodetector structure.

As indicated above, FIGS. 1A and 1B are provided as an example. Other examples may differ from what is described with regard to FIGS. 1A and 1B.

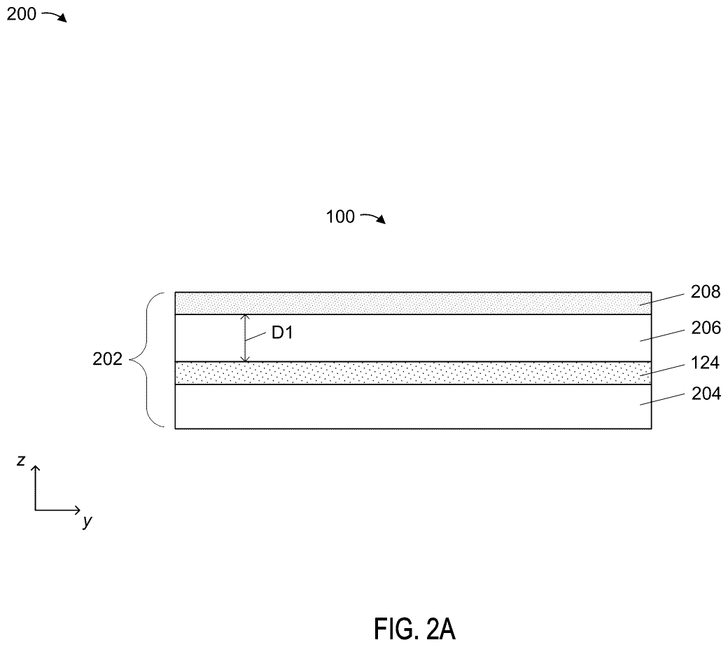

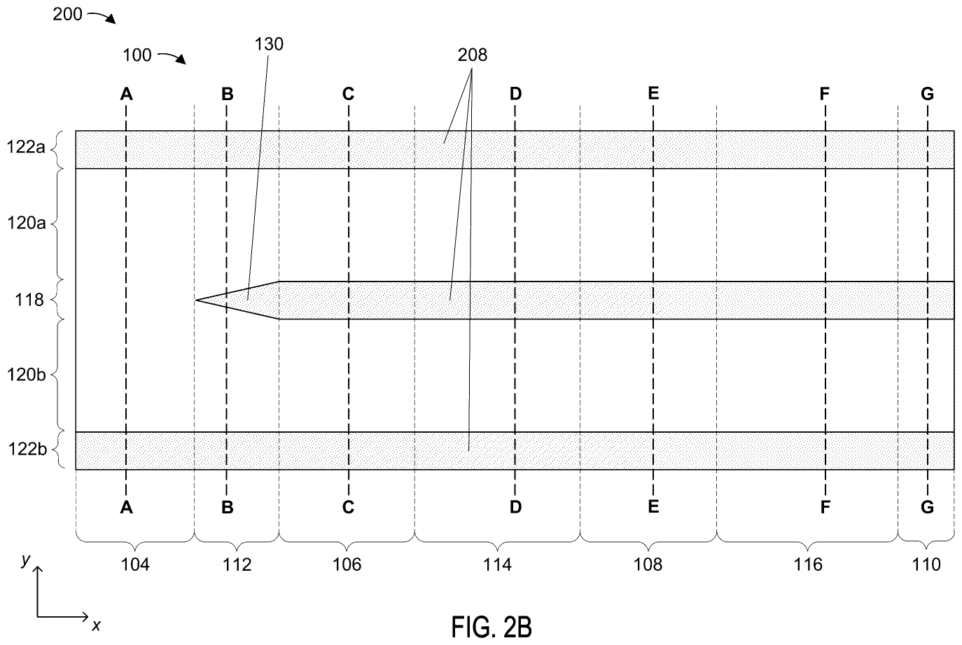

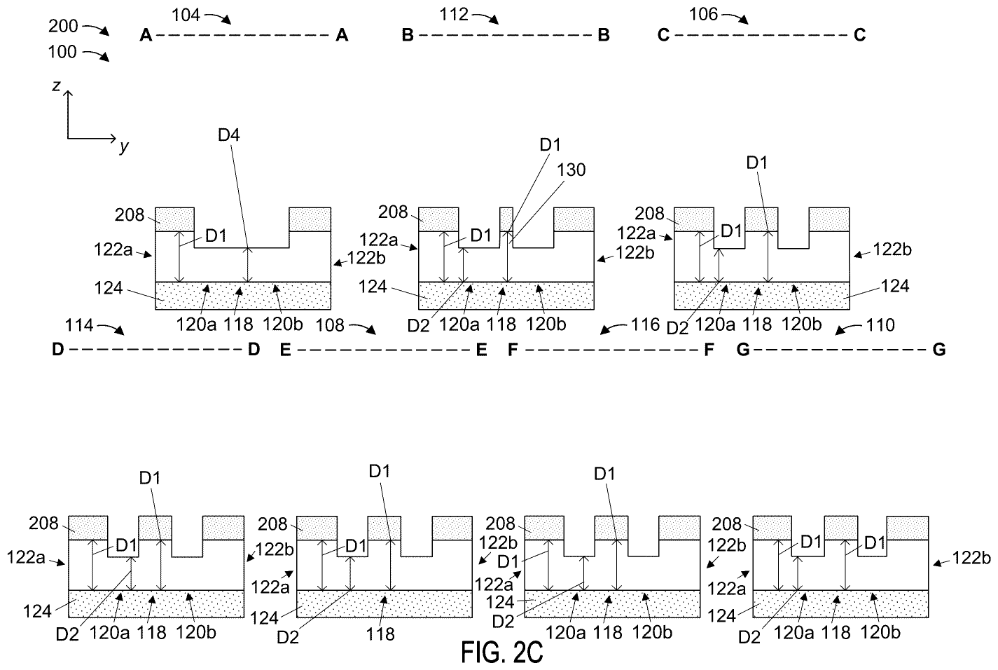

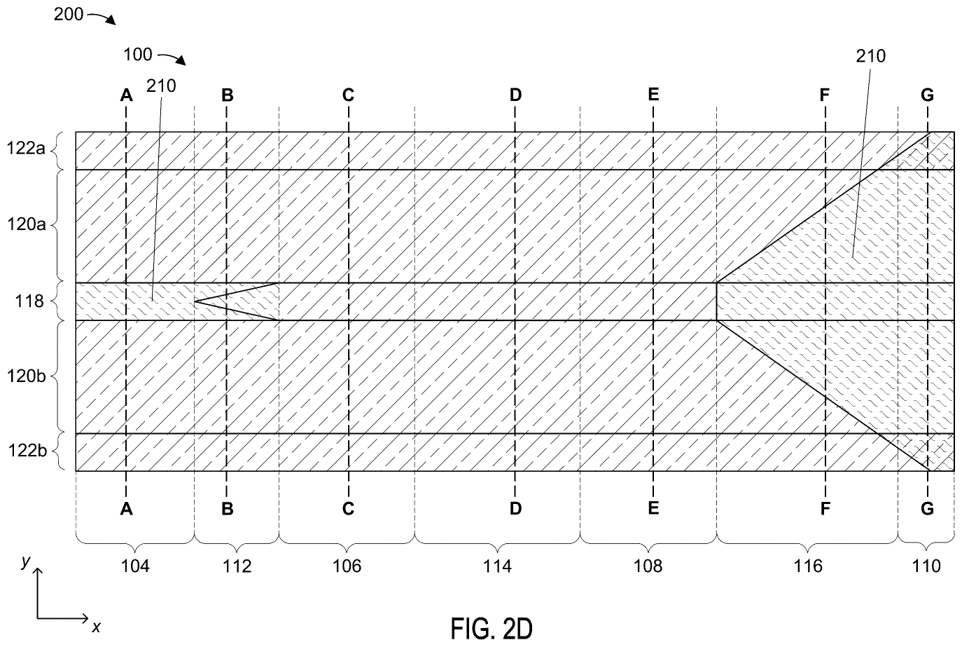

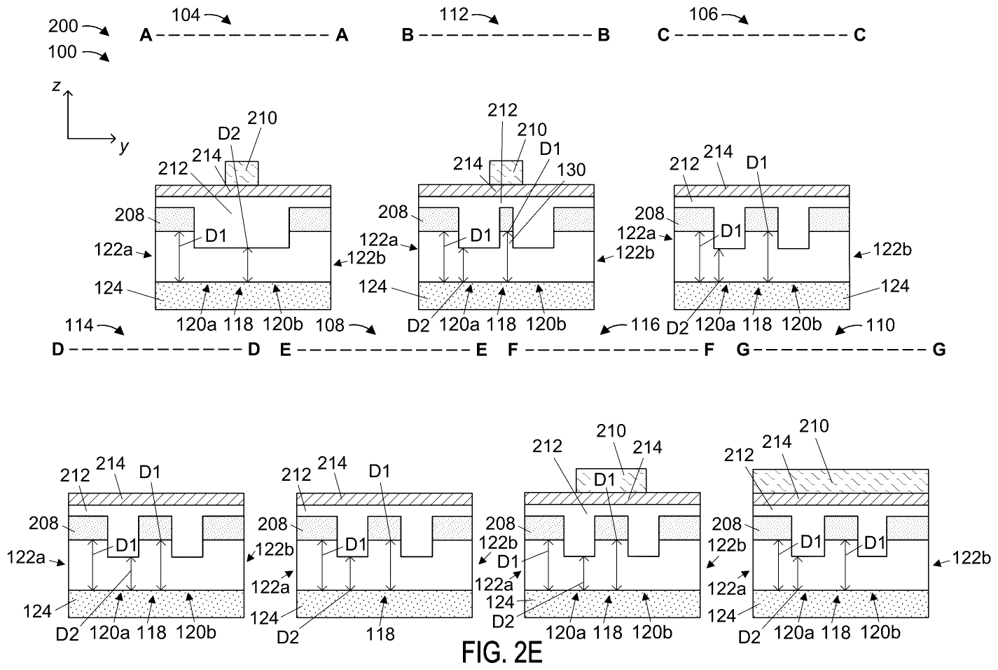

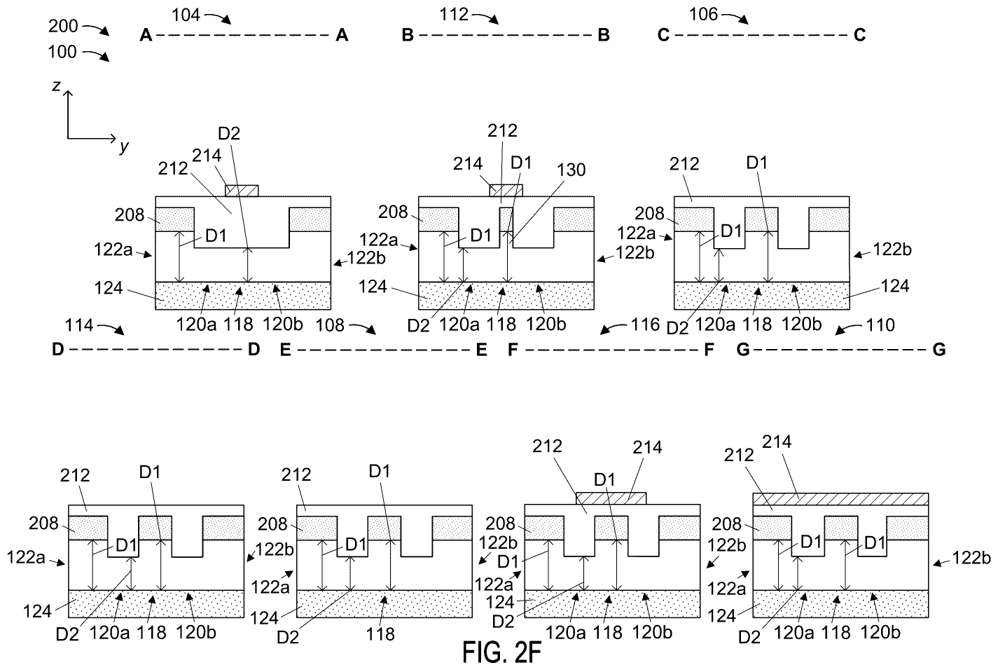

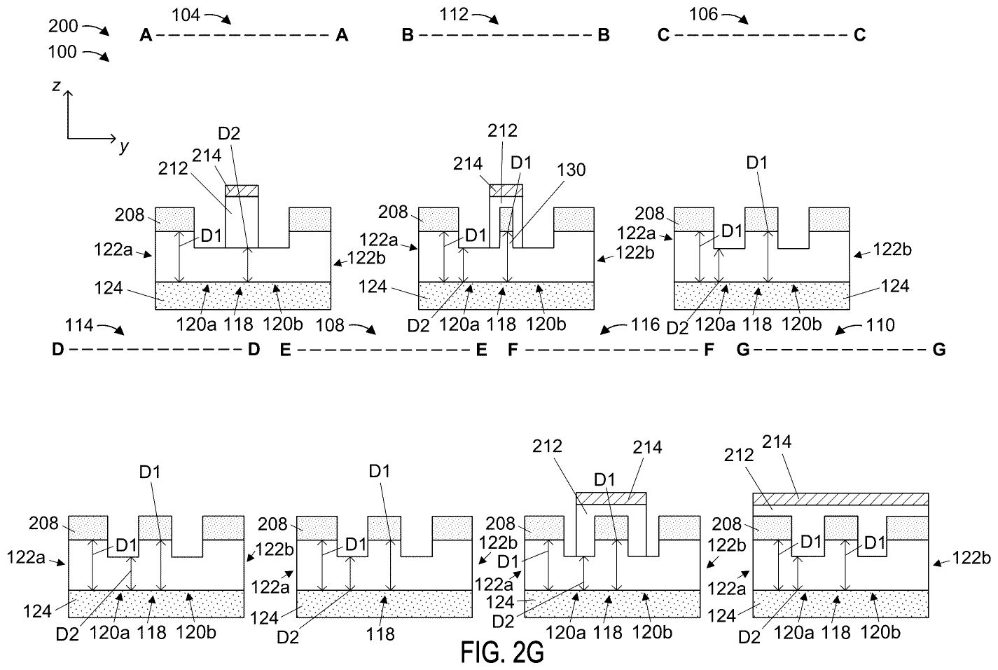

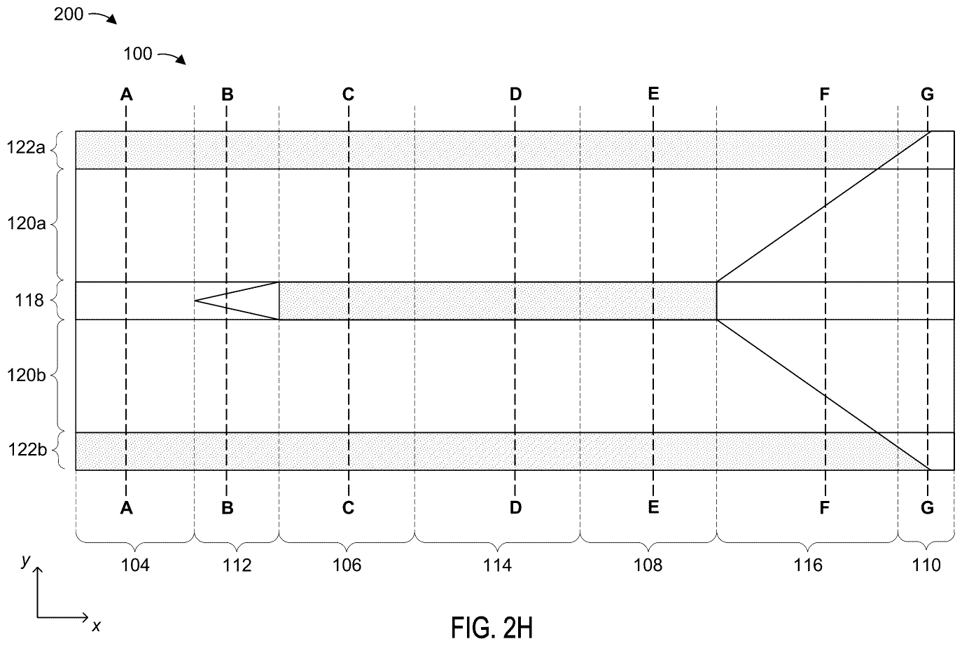

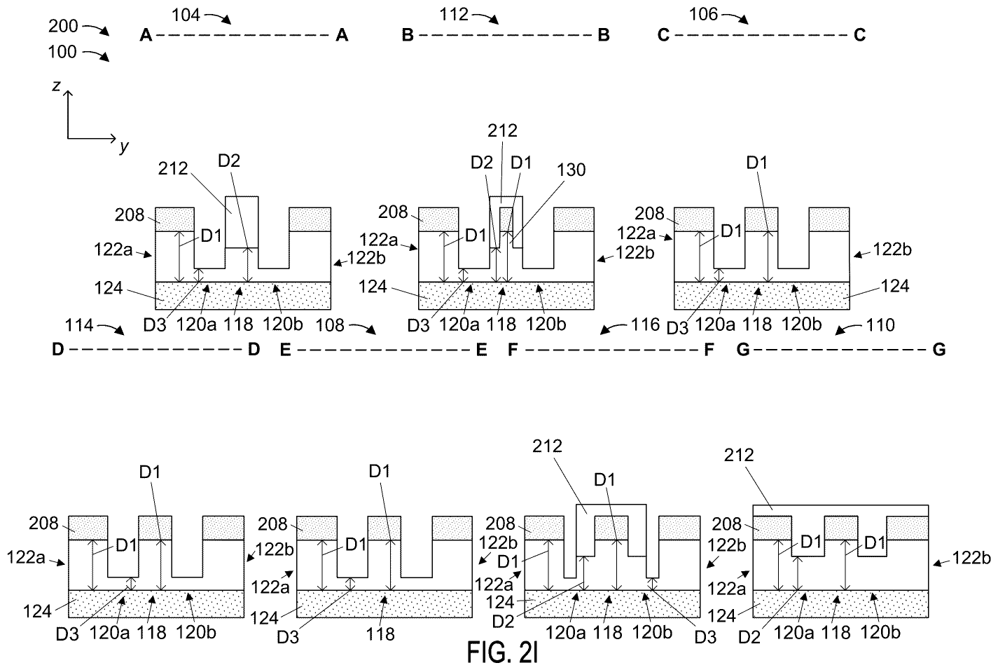

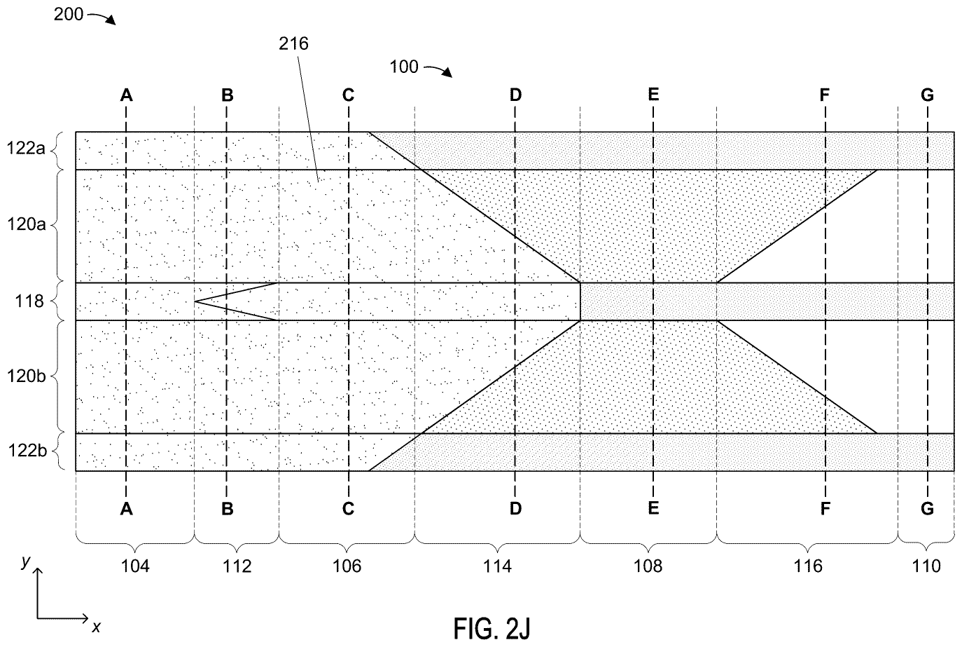

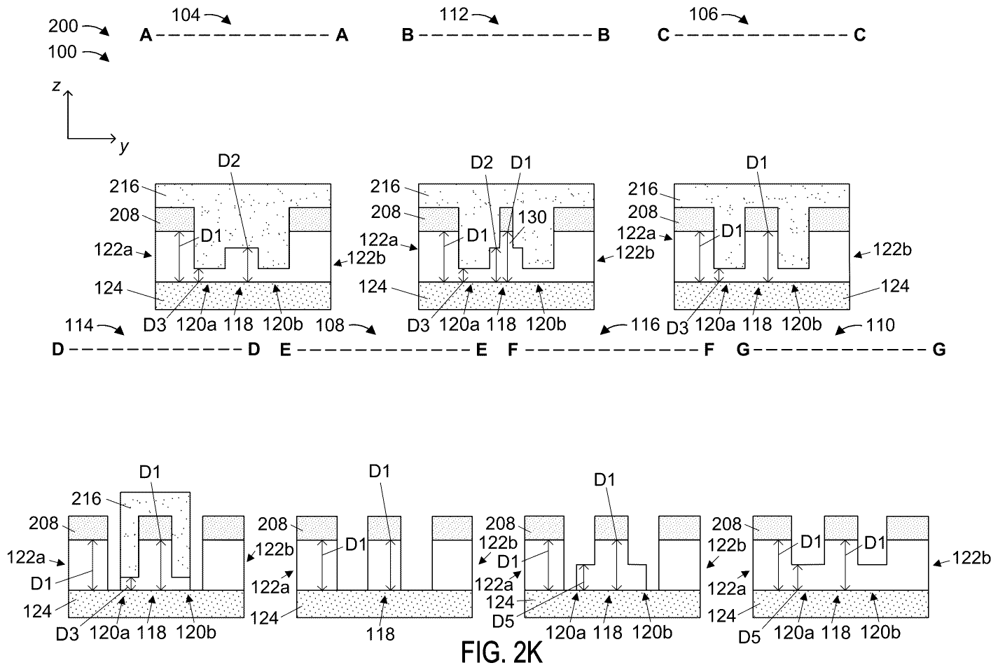

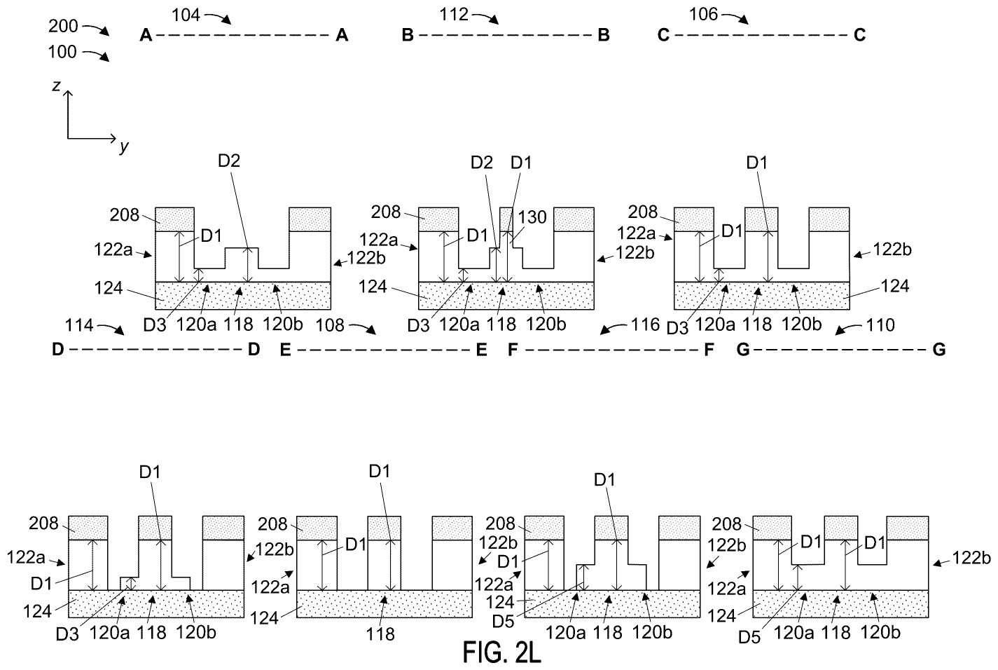

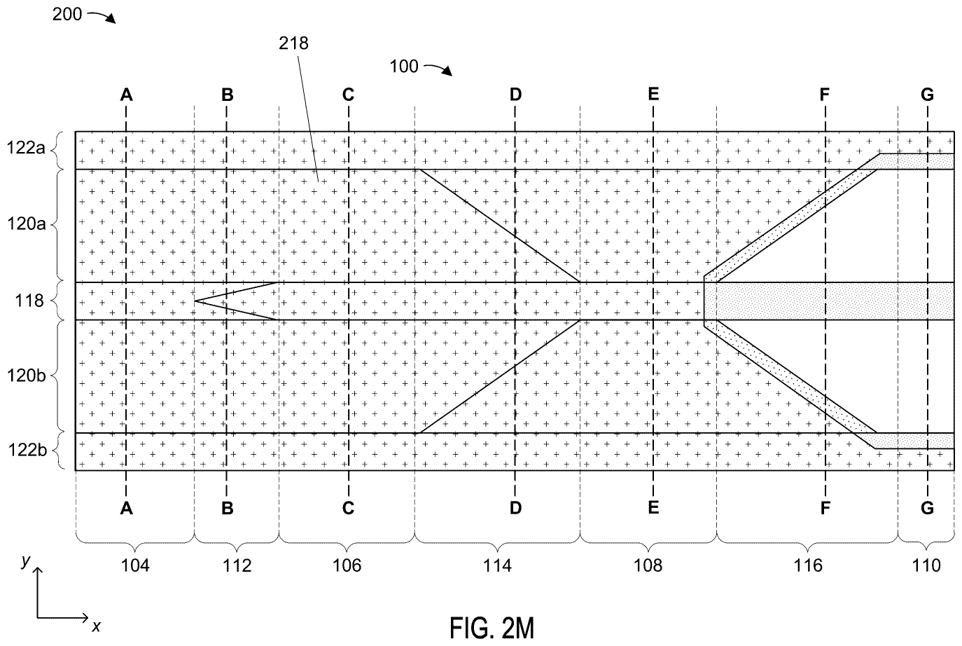

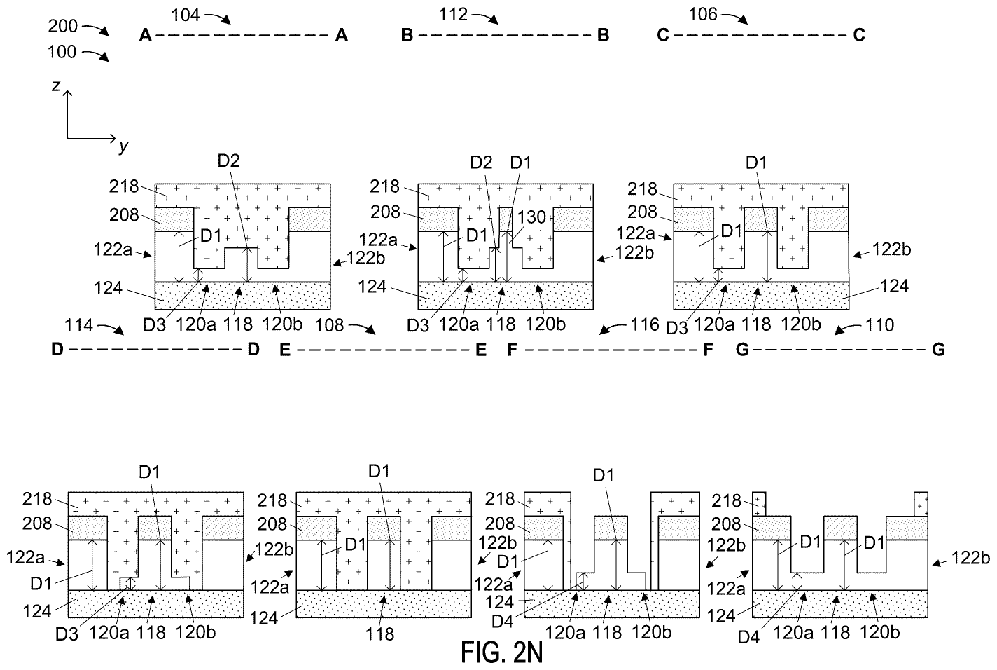

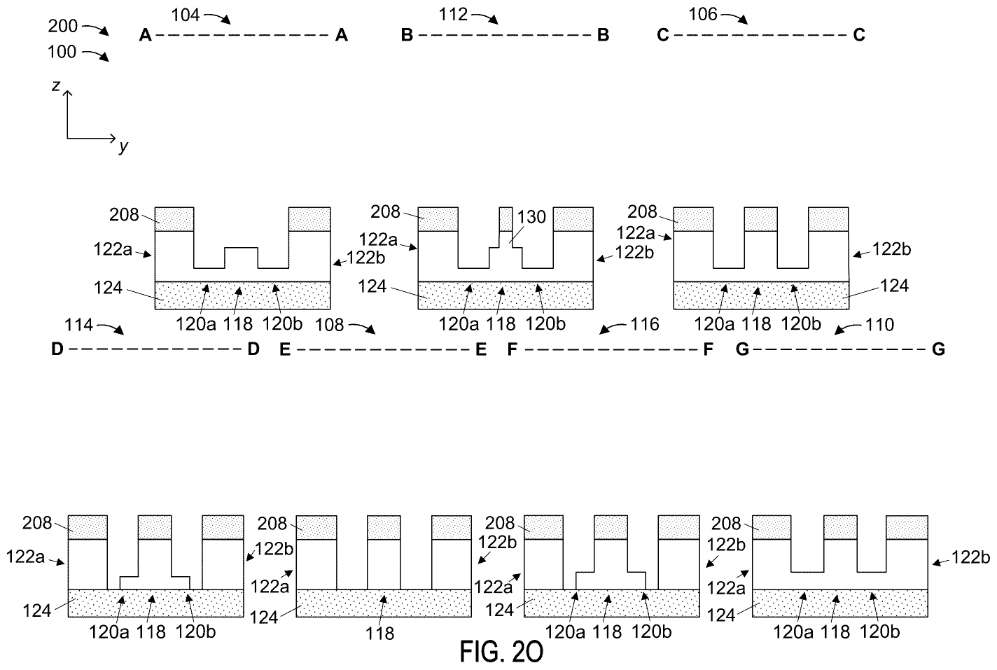

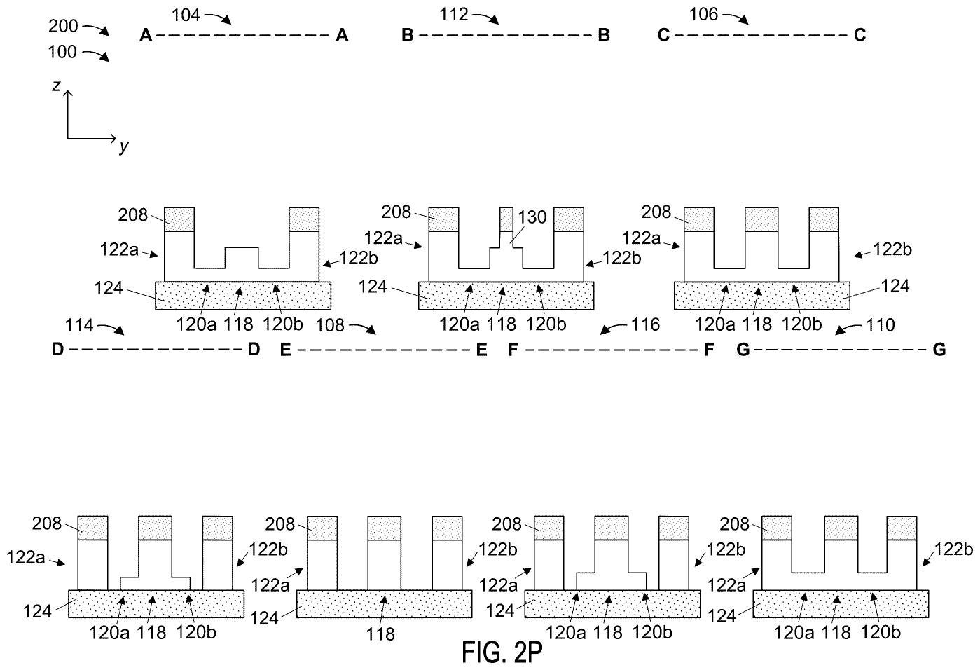

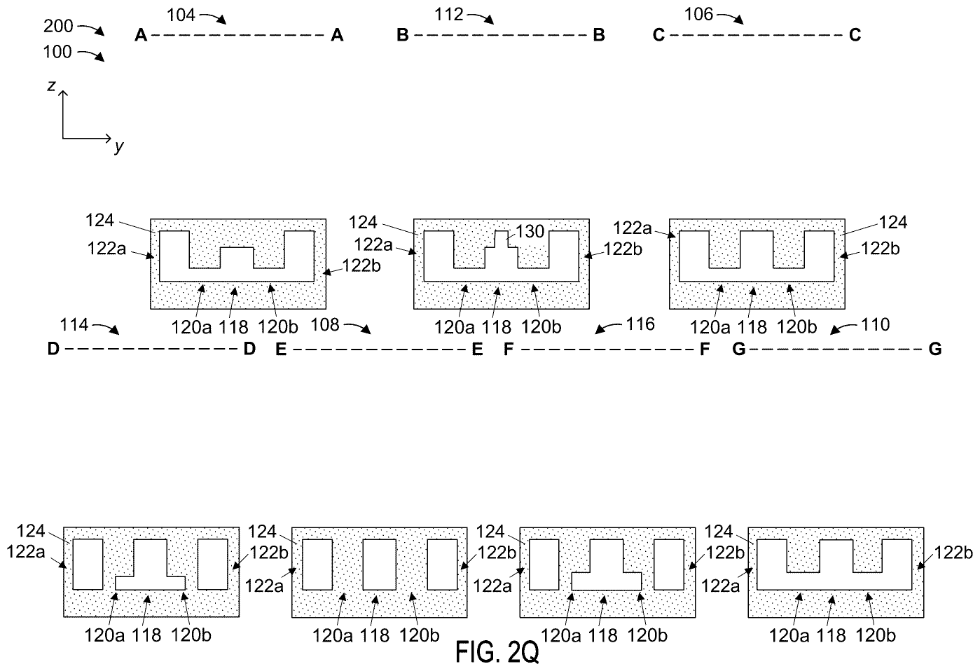

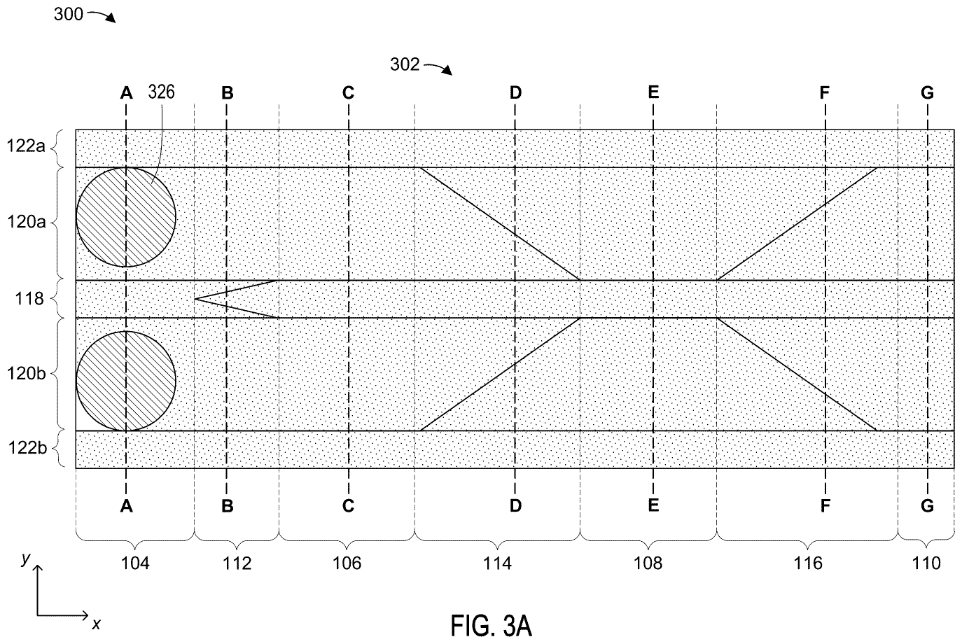

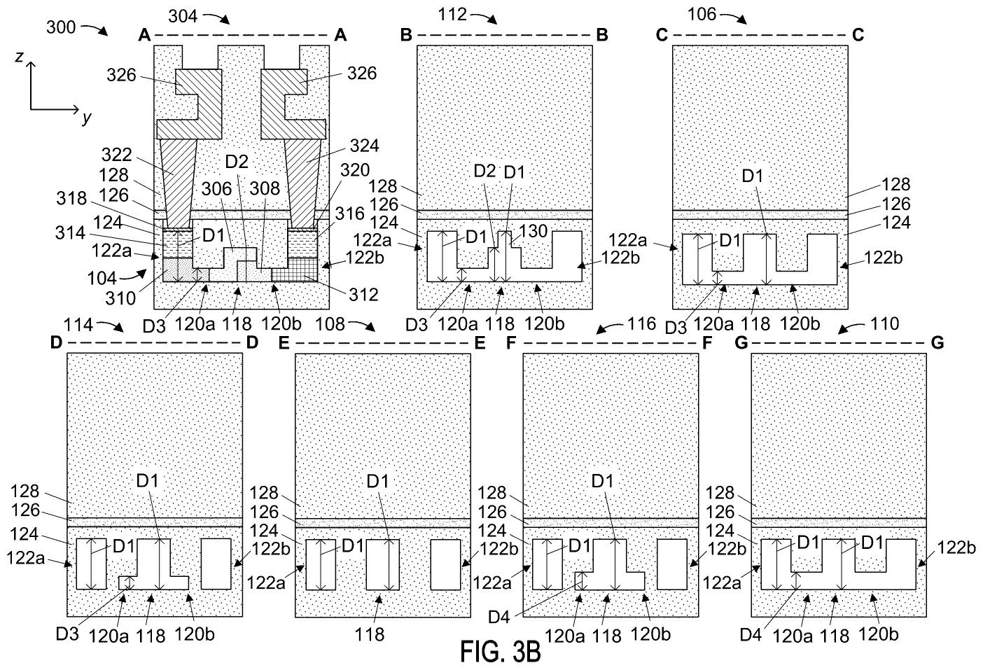

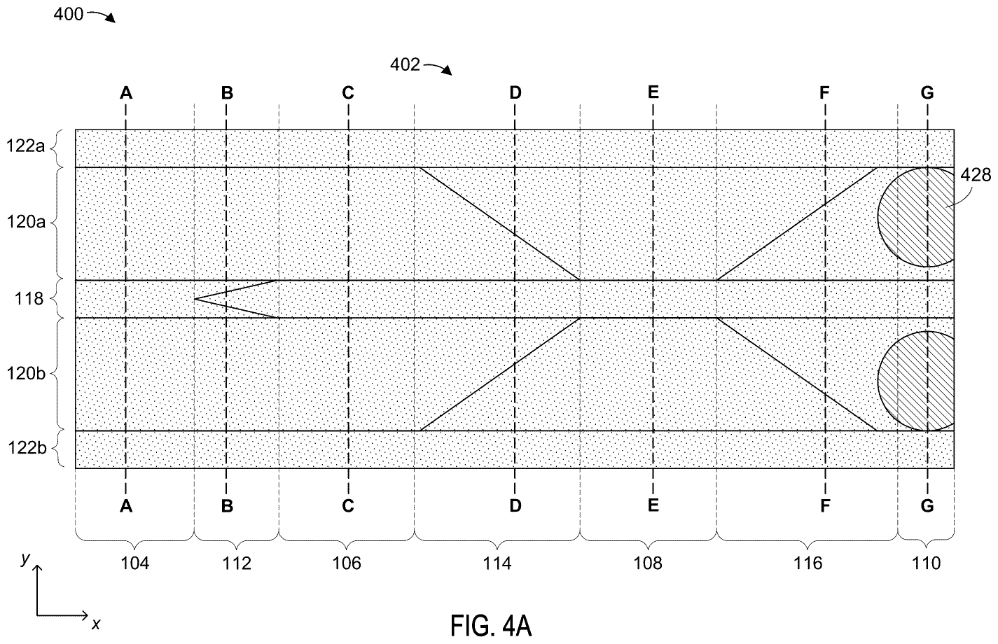

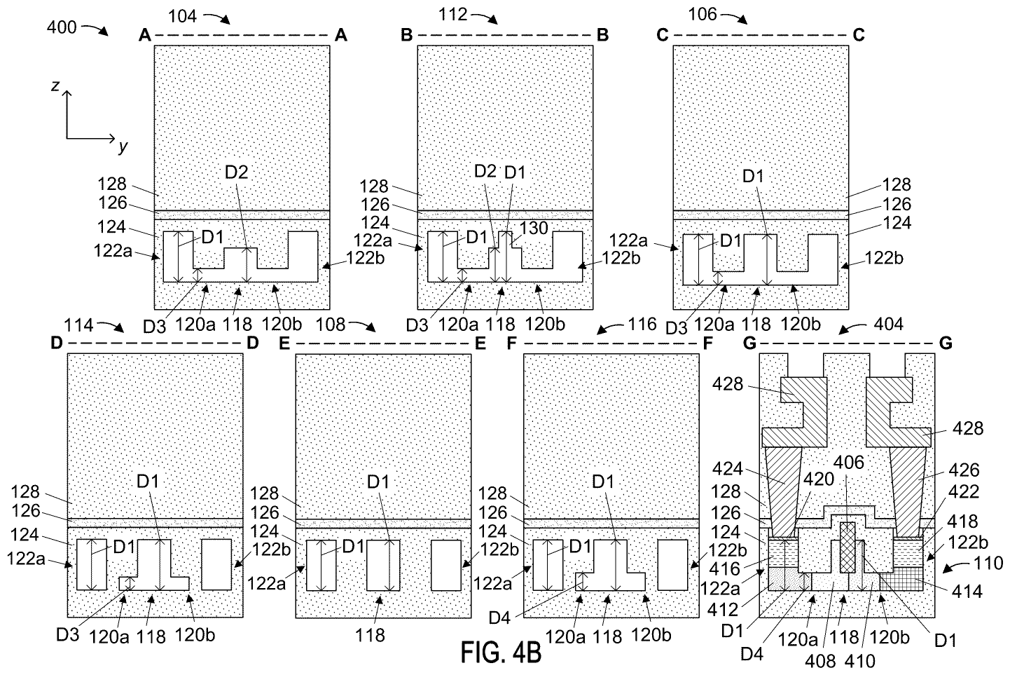

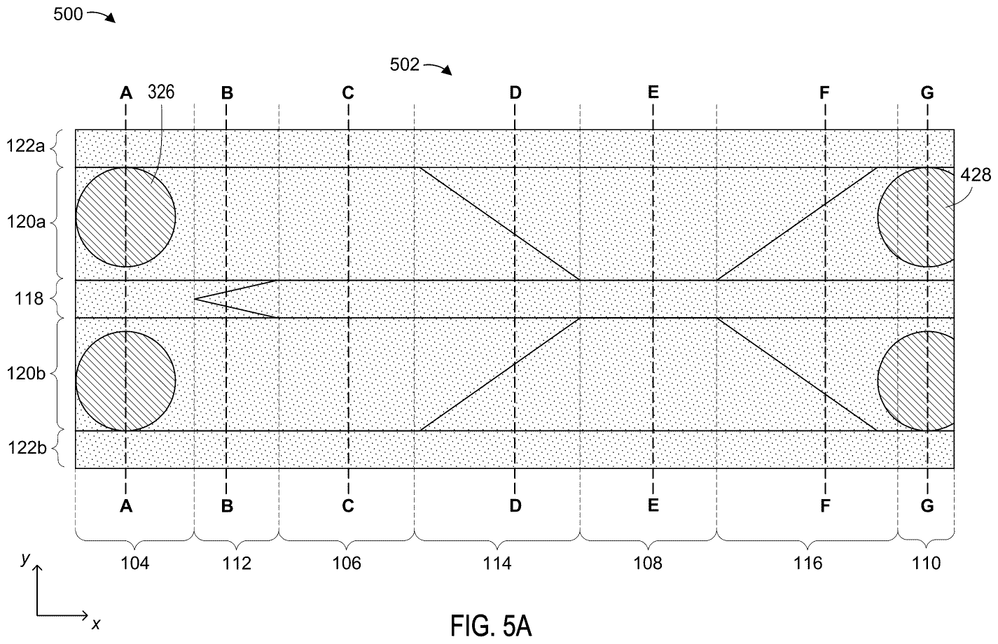

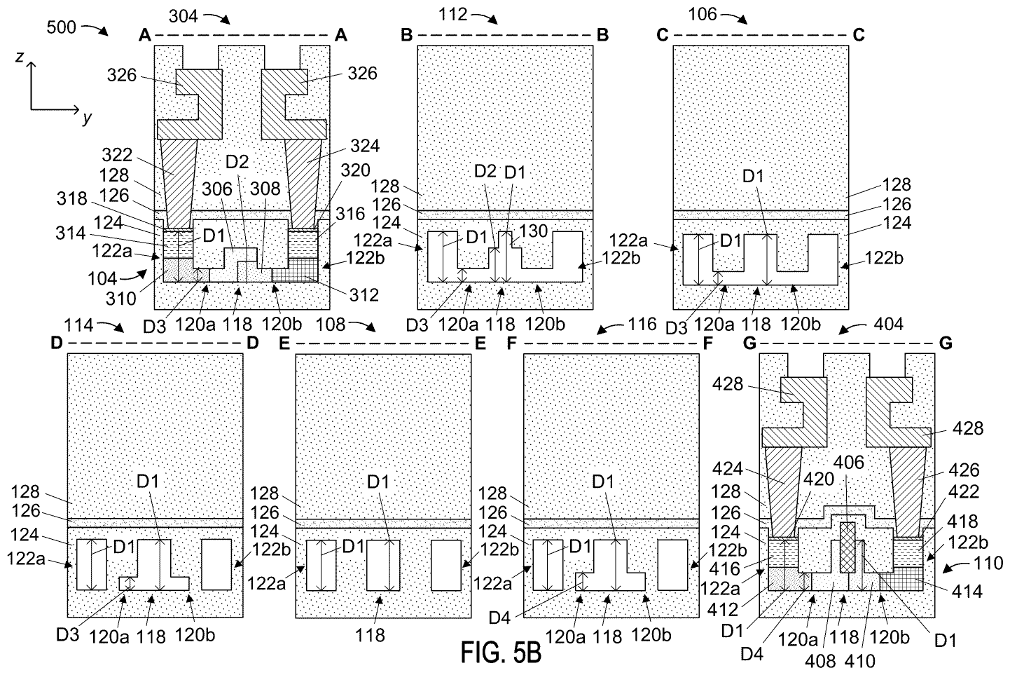

FIGS. 2A-2Q are diagrams of an example implementation 200 of forming the semiconductor photonics device 100 described herein. In some implementations, one or more of the operations described in connection with FIGS. 2A-2Q may be performed to form another semiconductor photonics device described herein, such as a semiconductor photonics device 300 illustrated and described in connection with FIGS. 3A and 3B, a semiconductor photonics device 400 illustrated and described in connection with FIGS. 4A and 4B, and/or a semiconductor photonics device 500 illustrated and described in connection with FIGS. 5A and 5B, among other examples. In some implementations, one or more of the operations described in connection with FIGS. 2A-2Q may be performed using one or more semiconductor processing tools, such as a deposition tool, an exposure tool, a developer tool, an etch tool, a planarization tool, an ion implantation tool, an annealing tool, and/or a wafer/die transport tool, among other examples.

Turning to FIG. 2A, a substrate 202 may be provided. The substrate 202 may include a silicon on insulator (SOI) substrate that includes a substrate layer 204 (e.g., a silicon (Si) substrate and/or another type of semiconductor substrate), a portion of the dielectric region 124 (e.g., a buried oxide or bottom oxide (BOX) layer and/or another type of insulator layer) over and/or on the substrate layer 204, and a semiconductor layer 206 (e.g., a silicon (Si) layer and/or another type of semiconductor layer) over and/or on the portion of the dielectric region 124. Alternatively, the substrate layer 204 may be provided as a semiconductor wafer, and a deposition tool may be used to form the portion of the dielectric region 124 over and/or on the substrate layer 204, and may form the semiconductor layer 206 over and/or on the portion of the dielectric region 124. A deposition tool may be used to deposit the portion of the dielectric region 124 using a chemical vapor deposition (CVD) technique, a physical vapor deposition (PVD) technique, an oxidation technique (e.g., a thermal oxidation technique), and/or another type of deposition technique. A deposition tool may be used to form the semiconductor layer 206 using an epitaxy technique and/or another type of deposition technique. The semiconductor layer 206 may be formed or provided at a vertical (z-direction) thickness corresponding to the dimension D1.

As further shown in FIG. 2A, a masking layer 208 may be formed on the semiconductor layer 206. The masking layer 208 may include a hard mask layer and/or another type of layer that may be patterned and used to etch the semiconductor layer 206. The masking layer 208 may include one or more dielectric materials, such as a silicon nitride (SiₓN_{y}), silicon carbide (SiC), silicon oxynitride (SiON), and/or an aluminum oxide (AlₓO_{y} such as Al₂O₃), among other examples. A deposition tool may be used to deposit the masking layer 208 using a PVD technique, an atomic layer deposition technique (ALD) technique, a CVD technique, and/or another suitable deposition technique. The masking layer 208 may be deposited in one or more deposition operations. In some implementations, a planarization tool may be used to perform a planarization operation (e.g., a chemical-mechanical planarization (CMP) operation) to planarize the masking layer 208 after the masking layer 208 is deposited.

As shown in FIGS. 2B and 2C, a first patterning and etching sequence may be performed to etch the semiconductor layer 206 using the masking layer 208 to form various semiconductor photonic components from the semiconductor layer 206. For example, the semiconductor layer 206 may be etched using the masking layer 208 to form the rib optical waveguide structure 104, the rib optical waveguide structure 106, the strip optical waveguide structure 108, the rib optical waveguide structure 110, and/or the associated transition regions 112, 114, and 116. In some implementations, a photoresist layer may be patterned and used to transfer a pattern to the masking layer 208, and the pattern in the masking layer 208 may be used to etch the semiconductor layer 206. In some implementations, a photoresist layer may be patterned and used to etch the masking layer 208 and the semiconductor layer 206 based on the pattern in the photoresist layer.

As shown in FIGS. 2B and 2C, the rib optical waveguide structure 104, the rib optical waveguide structure 106, the strip optical waveguide structure 108, the rib optical waveguide structure 110, and/or the associated transition regions 112, 114, and 116 may be formed to each include a ridge section 118, slab sections 120a and 120b on opposing sides of the ridge section 118 in the y-direction, and terminal sections 122a and 122b respectively laterally adjacent to the slab sections 120a and 120b in the y-direction. Moreover, the transition region 112 may be formed to include the tapered section 130 above the ridge section 118.

As shown in FIG. 2C, the masking layer 208 is maintained over the terminal sections 122a and 122b of the rib optical waveguide structure 104, the rib optical waveguide structure 106, the strip optical waveguide structure 108, the rib optical waveguide structure 110, and/or the associated transition regions 112, 114, and 116 such that the terminal sections 122a and 122b remain at the vertical (z-direction) thickness corresponding to the dimension D1 after the first patterning and etching sequence. Similarly, the masking layer 208 is maintained over the tapered section 130 of the rib optical waveguide structure 106 and the ridge sections 118 of the strip optical waveguide structure 108, the rib optical waveguide structure 110, and/or the associated transition regions 112, 114, and 116 such that the tapered section 130 of the rib optical waveguide structure 106 and the ridge sections 118 of the strip optical waveguide structure 108, the rib optical waveguide structure 110, and/or the associated transition regions 112, 114, and 116 remain at the vertical (z-direction) thickness corresponding to the dimension D1 after the first patterning and etching sequence.

However, in the first patterning and etching sequence, portions of the masking layer 208 are removed from over the ridge sections 118 of the rib optical waveguide structures 104 and 106, and from over the slab sections 120a and 120b of the rib optical waveguide structure 104, the rib optical waveguide structure 106, the strip optical waveguide structure 108, the rib optical waveguide structure 110, and the associated transition regions 112, 114, and 116. This enables the ridge sections 118 of the rib optical waveguide structures 104 and 106, and the slab sections 120a and 120b of the rib optical waveguide structure 104, the rib optical waveguide structure 106, the strip optical waveguide structure 108, the rib optical waveguide structure 110, and the associated transition regions 112, 114, and 116, to be formed to a vertical (z-direction) thickness corresponding to the dimension D2. In other words, the first patterning and etching sequence may be performed to form the ridge sections 118 of the rib optical waveguide structure 104 and 106 to a lesser vertical (z-direction) thickness than the vertical (z-direction) thickness of the ridge sections 118 of the rib optical waveguide structure 106, the strip optical waveguide structure 108, the rib optical waveguide structure 110, and/or the associated transition regions 112, 114, and 116.

The first patterning operation of the first patterning and etching sequence may include forming a pattern in the masking layer 208. A deposition tool may be used to form a photoresist layer on the masking layer 208 (e.g., using a spin-coating technique and/or another suitable deposition technique). An exposure tool may be used to expose the photoresist layer to a radiation source to pattern the photoresist layer. A developer tool may be used to develop and remove portions of the photoresist layer to expose the pattern. An etch tool may be used to etch the masking layer 208 based on the pattern to transfer the pattern to the masking layer 208.

The first etch operation of the first patterning and etching sequence may include etching the semiconductor layer 206 based on the patterning in the masking layer 208. In some implementations, the first etch operation includes a dry etch operation (e.g., a plasma-based etch operation, a gas-based etch operation), a wet chemical etch operation, and/or another type of etch operation. In some implementations, a photoresist removal tool may be used to remove the remaining portions of the photoresist layer (e.g., using a chemical stripper, plasma ashing, and/or another technique).

As shown in FIGS. 2D and 2E, a patterned masking layer 210 is formed on the semiconductor photonics device 100. As shown in FIG. 2D, the patterned masking layer 210 may be formed on the ridge section 118 of the rib optical waveguide structure 104, on the ridge section 118 and the tapered section 130 of the transition region 112, on the ridge section 118 and on a portion of the slab sections 120a and 120b of the transition region 116, and on the ridge section 118 the slab sections 120a and 120b of the rib optical waveguide structure 110. The patterned masking layer 210 may be formed such that the patterned masking layer 210 is tapered in the y-direction along the x-direction in the transition region 116.

As shown in FIG. 2E, the patterned masking layer 210 may be included as part of a multiple-layer mask that is formed on the semiconductor photonics device 100 after the first patterning and etching sequence. The multiple-layer mask may be formed as part of second patterning operation of a second patterning and etching sequence that is performed after the first patterning and etching sequence. The multiple-layer mask may include a masking layer 212 on the semiconductor photonics device 100, a masking layer 214 on the masking layer 212, and the patterned masking layer 210 on the masking layer 214.

The multiple-layer mask may include a multiple-layer photoresist stack. The patterned masking layer 210 may include a photoresist layer of the multiple-layer photoresist stack, the masking layer 212 may include a photoresist bottom layer of the multiple-layer photoresist stack, and the masking layer 214 may include a photoresist middle layer of the multiple-layer photoresist stack. In some implementations, a deposition tool is used to deposit each of the masking layers 212 and 214 using a spin-coating technique. In some implementations, a deposition tool is used to deposit each of the masking layers 212 and 214 using a PVD technique, an ALD technique, a CVD technique, and/or another suitable deposition technique.

The patterned masking layer 210 may be deposited as a photoresist layer, and an exposure tool may be used to expose the photoresist layer to a radiation source to pattern the photoresist layer to form the patterned masking layer 210. A developer tool may be used to develop and remove portions of the photoresist layer to expose the pattern in the patterned masking layer 210.

As shown in FIG. 2E, the patterned masking layer 210 may be included over the ridge sections 118 of the rib optical waveguide structure 104, the rib optical waveguide structure 110, and the transition regions 112 and 116. The patterned masking layer 210 may also be included over the slab sections 120a and 120b, and over the terminal sections 122a and 122b, of the rib optical waveguide structure 110. The patterned masking layer 210 may also be included over portions of the slab sections 120a and 120b of the transition region 116. Patterning the patterned masking layer 210 may remove portions of the patterned masking layer 210 from the rib optical waveguide structure 106, the strip optical waveguide structure 108, and the transition region 114. Moreover, patterning the patterned masking layer 210 may remove portions of the patterned masking layer 210 from the slab sections 120a and 120b, and the terminal sections 122a and 112b, of the rib optical waveguide structure 104 and the transition region 112.

As shown in FIG. 2F, the second patterning operation may further include transferring the pattern in the patterned masking layer 210 to the masking layer 214. In some implementations, an etch tool may be used to etch the masking layer 214 based on the pattern in the patterned masking layer 210 to transfer the pattern from the patterned masking layer 210 to the masking layer 214. In some implementations, the etch operation includes a dry etch operation (e.g., a plasma-based etch operation, a gas-based etch operation), a wet chemical etch operation, and/or another type of etch operation. In some implementations, a photoresist removal tool may be used to remove the remaining portions of the patterned masking layer 210 (e.g., using a chemical stripper, plasma ashing, and/or another technique).

As shown in FIG. 2G, the second patterning operation may further include transferring the pattern in the masking layer 214 to the masking layer 212. In some implementations, an etch tool may be used to etch the masking layer 212 based on the pattern in the masking layer 214 to transfer the pattern from the masking layer 214 to the masking layer 212. In some implementations, the etch operation includes a dry etch operation (e.g., a plasma-based etch operation, a gas-based etch operation), a wet chemical etch operation, and/or another type of etch operation.

Portions of the masking layers 212 and 214 may remain over the ridge sections 118 of the rib optical waveguide structure 104, the rib optical waveguide structure 110, the transition region 112, and the transition region 116. Portions of the masking layers 212 and 214 may remain over the slab sections 120a and 120b of the rib optical waveguide structure 110, and over portions of the slab sections 120a and 120b of the transition region 116. Portions of the masking layers 212 and 214 may remain over the terminal sections 122a and 122b of the rib optical waveguide structure 110. Portions of the masking layers 212 and 214 may remain over the tapered section 130 of the transition region 112.

As shown in FIGS. 2H and 2I, the second etch operation of the second patterning and etching sequence may include etching the semiconductor layer 206 based on the pattern in the masking layers 212 and 214. In some implementations, the second etch operation includes a dry etch operation (e.g., a plasma-based etch operation, a gas-based etch operation), a wet chemical etch operation, and/or another type of etch operation. As shown in FIG. 2H, in the second etch operation, the semiconductor layer 206 may be etched to form a lateral taper in the slab sections 120a and 120b in the transition region 116. The slab sections 120a and 120b may be tapered in the y-direction along the x-direction in the transition region 116. The slab sections 120a and 120b may increase in lateral width in the y-direction along the x-direction from the strip optical waveguide structure 108 to the rib optical waveguide structure 110.

As shown in FIG. 2I, in the second etch operation, the semiconductor layer 206 may be etched to reduce a vertical (z-direction) thickness of the slab sections 120a and 120b of the rib optical waveguide structure 104, the rib optical waveguide structure 106, the strip optical waveguide structure 108, the transition region 112, and the transition region 114 from the dimension D2 to the dimension D3. Moreover, in the second etch operation, the semiconductor layer 206 may be etched to reduce a vertical (z-direction) thickness of a portion of the slab sections 120a and 120b of the transition region 116 from the dimension D2 to the dimension D3.

The masking layers 208, 212, and/or 214 may protect the ridge sections 118 and the terminal sections 122a and 122b of the rib optical waveguide structure 104, the rib optical waveguide structure 106, the strip optical waveguide structure 108, the rib optical waveguide structure 110, and the associated transition regions 112, 114, and 116 from being etched in the second etch operation. Thus, the terminal sections 122a and 122b of the rib optical waveguide structure 104, the rib optical waveguide structure 106, the strip optical waveguide structure 108, the rib optical waveguide structure 110, and the associated transition regions 112, 114, and 116 remain at the vertical (z-direction) thickness corresponding to the dimension D1 after the second etch operation. Moreover, the ridge sections 118 of the rib optical waveguide structure 104 and the transition region 112 remain at the vertical (z-direction) thickness corresponding to the dimension D2 after the second etch operation. Moreover, the ridge sections 118 of the rib optical waveguide structure 106, the strip optical waveguide structure 108, the rib optical waveguide structure 110, and the transition regions 114 and 116 remain at the vertical (z-direction) thickness corresponding to the dimension D1 after the second etch operation. The tapered section 130 of the transition region 112 may also remain at the vertical (z-direction) thickness corresponding to the dimension D1 after the second etch operation.

Moreover, the masking layers 212 and 214 may protect the slab sections 120a and 120b of the rib optical waveguide structure 110 from being etched in the second etch operation. Thus, the slab sections 120a and 120b of the rib optical waveguide structure 110 remain at the vertical (z-direction) thickness corresponding to the dimension D2 after the second etch operation.

The masking layer 214 may be consumed during the second etch operation. The remaining portions of the masking layer 212 may be subsequently removed after the second etch operation. In some implementations, the remaining portions of the masking layer 212 are removed by plasma ashing, etching, and/or another removal technique.

As shown in FIGS. 2J and 2K, a third patterning and etching sequence may be performed to etch the slab sections 120a and 120b of the strip optical waveguide structure 108 and the transition region 114. A third patterning operation of the third patterning and etching sequence may include forming a masking layer 216 over the semiconductor photonics device 100 and forming a pattern in the masking layer 216. A third etch operation of the third patterning and etching sequence may include etching the slab sections 120a and 120b of the strip optical waveguide structure 108 and the transition region 114 based on the pattern in the masking layer 216 to remove the slab sections 120a and 120b from the strip optical waveguide structure 108 and from a portion of the transition region 114.

A deposition tool may be used to form the masking layer 216 on the semiconductor photonics device 100 (e.g., using a spin-coating technique and/or another suitable deposition technique). An exposure tool may be used to expose the masking layer 216 to a radiation source to pattern the masking layer 216. A developer tool may be used to develop and remove portions of the masking layer 216 to expose the pattern. Portions of the masking layer 216 may remain over the rib optical waveguide structure 104, the rib optical waveguide structure 106, and the transition regions 112 and 114. An etch tool may be used to etch the semiconductor layer 206 based on the pattern in the masking layer 216. In some implementations, the etch operation includes a dry etch operation (e.g., a plasma-based etch operation, a gas-based etch operation), a wet chemical etch operation, and/or another type of etch operation.

As shown in FIG. 2J, the third etch operation results in a lateral taper in the slab sections 120a and 120b in the transition region 114. The slab sections 120a and 120b may be tapered in the y-direction along the x-direction in the transition region 114. The slab sections 120a and 120b may increase in lateral width in the y-direction along the x-direction from the strip optical waveguide structure 108 to the rib optical waveguide structure 106.

As shown in FIG. 2K, in the third etch operation, the masking layer 216 protects the rib optical waveguide structure 104, the rib optical waveguide structure 106, the transition region 112, and a portion of the transition region 114. Moreover, in the third etch operation, the vertical (z-direction) thickness of the slab sections 120a and 120b of the rib optical waveguide structure 110 and the transition region 116 is reduced from the dimension D2 to a dimension D5. The dimension D5 may be greater than the dimension D3, and may be included in a range of approximately 120 nanometers to approximately 150 nanometers. However, other values and ranges for the dimension D5 are within the scope of the present disclosure.

As shown in FIG. 2L, a photoresist removal tool may be used to remove the remaining portions of the masking layer 216 (e.g., using a chemical stripper, plasma ashing, and/or another technique) after the third etch operation.

As shown in FIGS. 2M and 2N, a fourth patterning and etching sequence may be performed to etch the slab sections 120a and 120b of the rib optical waveguide structure 110 and the transition region 116. A fourth patterning operation of the fourth patterning and etching yessequence may include forming a masking layer 218 over the semiconductor photonics device 100 and forming a pattern in the masking layer 218. A fourth etch operation of the third patterning and etching sequence may include etching the slab sections 120a and 120b of the rib optical waveguide structure 110 and the transition region 116 based on the pattern in the masking layer 218 to reduce a vertical (z-direction) thickness of the slab sections 120a and 120b of the rib optical waveguide structure 110 and the transition region 116 from the dimension D5 to the dimension D4.

A deposition tool may be used to form the masking layer 218 on the semiconductor photonics device 100 (e.g., using a spin-coating technique and/or another suitable deposition technique). An exposure tool may be used to expose the masking layer 218 to a radiation source to pattern the masking layer 218. A developer tool may be used to develop and remove portions of the masking layer 218 to expose the pattern. Portions of the masking layer 218 may remain over the rib optical waveguide structure 104, the rib optical waveguide structure 106, the strip optical waveguide structure 108, and the transition regions 112 and 114. Portions of the masking layer 218 may also remain over the terminal sections 122a and 122b (or a portion thereof) of the rib optical waveguide structure 110 and the transition region 116.

An etch tool may be used to etch the semiconductor layer 206 based on the pattern in the masking layer 218. In some implementations, the etch operation includes a dry etch operation (e.g., a plasma-based etch operation, a gas-based etch operation), a wet chemical etch operation, and/or another type of etch operation.

As shown in FIG. 2M, the fourth etch operation results in a lateral taper in the slab sections 120a and 120b in the transition region 116. The slab sections 120a and 120b may be tapered in the y-direction along the x-direction in the transition region 116. The slab sections 120a and 120b may increase in lateral width in the y-direction along the x-direction from the strip optical waveguide structure 108 to the rib optical waveguide structure 110.

As shown in FIG. 2N, in the fourth etch operation, the masking layer 218 protects the rib optical waveguide structure 104, the rib optical waveguide structure 106, the transition region 112, and a portion of the transition region 114. Moreover, in the fourth etch operation, the vertical (z-direction) thickness of the slab sections 120a and 120b of the rib optical waveguide structure 110 and the transition region 116 is reduced from the dimension D5 to the dimension D4.

As shown in FIG. 2O, a photoresist removal tool may be used to remove the remaining portions of the masking layer 218 (e.g., using a chemical stripper, plasma ashing, and/or another technique) after the third etch operation.

As shown in FIG. 2P, portions of the terminal sections 122a and 122b may be etched to define the lateral width of the terminal sections 122a and 122b and to provide areas adjacent to the terminal sections 122a and 122b in which a shallow trench isolation (STI) portion of the dielectric region 124 may be formed. In some implementations, a pattern in a photoresist layer is used to etch the terminal sections 122a and 122b. In these implementations, a deposition tool may be used to form the photoresist layer on the semiconductor photonics device 100 (e.g., using a spin-coating technique and/or another suitable deposition technique). An exposure tool may be used to expose the photoresist layer to a radiation source to pattern the photoresist layer. A developer tool may be used to develop and remove portions of the photoresist layer to expose the pattern. An etch tool may be used to etch the terminal sections 122a and 122b based on the pattern. In some implementations, the etch operation includes a dry etch operation (e.g., a plasma-based etch operation, a gas-based etch operation), a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for etching the terminal sections 122a and 122b based on a pattern.

As shown in FIG. 2Q, a planarization tool may be used to perform a planarization operation (e.g., a CMP operation) to remove the remaining portions of the masking layer 208 from the semiconductor photonics device 100. A deposition tool may be used to deposit the STI portion of the dielectric region 124 using a PVD technique, an ALD technique, a CVD technique, an oxidation technique, and/or another suitable deposition technique. The STI portion of the dielectric region 124 may be deposited in one or more deposition operations. In some implementations, a planarization tool may be used to perform a planarization operation (e.g., a CMP operation) to planarize the dielectric region 124 after the dielectric region 124 is deposited.

As indicated above, FIGS. 2A-2Q are provided as an example. Other examples may differ from what is described with regard to FIGS. 2A-2Q.

FIGS. 3A and 3B are diagrams of an example semiconductor photonics device 300 described herein. As shown in FIGS. 3A and 3B, the semiconductor photonics device 300 includes a photonic integrated circuit 302 that includes a similar combination and arrangement of layers and structures as the photonic integrated circuit 102 of the semiconductor photonics device 100. However, in the semiconductor photonics device 300, the rib optical waveguide structure 104 of the semiconductor photonics device 300 is included in an optical modulator structure 304 of the photonic integrated circuit 302. The optical modulator structure 304 may be configured to modulate optical signals to generate modulated optical signals. The optical modulator structure 304 may include an MRM, an MZM, and/or another type of optical modulator structure.

The rib optical waveguide structure 106, the strip optical waveguide structure 108, and/or the rib optical waveguide structure 110 may be configured to provide optical signals to and/or receive modulated optical signals from the optical modulator structure 304. In some implementations, the strip optical waveguide structure 108 is configured as a splitter structure (or a polarizer-splitter-rotator (PSR) waveguide) that splits optical signals prior to the optical signals being provided to the optical modulator structure 304.

As shown in FIG. 3B, various regions of the rib optical waveguide structure 106 may be doped to form a p-n junction in the ridge section 118 of the rib optical waveguide structure 106. For example, a p-n junction may be formed at an interface between doped regions 306 and 308 in the ridge section 118 of the rib optical waveguide structure 106. The doped regions 306 and 308 may include a semiconductor material (e.g., silicon (Si) and/or another suitable semiconductor material) that is doped with opposing dopant types. For example, the doped region 306 may be doped with one or more p-type dopants (e.g., boron (B) and/or gallium (Ga), among other examples) and the doped region 308 may be doped with one or more n-type dopants (e.g., phosphorous (P) and/or arsenic (As), among other examples).

Additional regions of the rib optical waveguide structure 106 may be doped to promote the flow of electrons and/or electron holes between the p-n junction in the ridge section 118 and the terminal sections 122a, 122b through the slab sections 120a, 120b. For example, a doped region 310 may be included in the slab section 120a and in the terminal section 122a, and a doped region 312 may be included in the slab section 120b and in the terminal section 122b. As another example, a doped region 314 may be included in the terminal section 122a, and a doped region 316 may be included in the terminal section 122b. The doped region 310 may have a greater dopant concentration than the dopant concentration of the doped region 306, and the doped region 314 may have a greater dopant concentration than the dopant concentration of the doped region 310. The doped region 312 may have a greater dopant concentration than the dopant concentration of the doped region 308, and the doped region 316 may have a greater dopant concentration than the dopant concentration of the doped region 312.

When the input electrical signal is applied to the p-n junction of the optical modulator structure 404, a junction depletion width of the p-n junction is modified. This results in changes in concentrations of electrons and electron holes within the ridge section 118 of the rib optical waveguide structure 104. The changes in concentrations of electrons and electron holes may lead to changes of the effective refractive index in the ridge section 118, which may modulate input optical signals (e.g., the phase and/or another property of the input optical signals) to generate a modulated optical signal.

As described above in connection with FIG. 1B, the ridge section 118 of the rib optical waveguide structure 104 may have a lesser vertical (z-direction) thickness than the vertical (z-direction) thickness of the ridge sections 118 of the rib optical waveguide structures 106 and 110 (e.g., D2<D1). Moreover, the slab sections 120a, 120b of the rib optical waveguide structure 104 may have a lesser vertical (z-direction) thickness than the vertical (z-direction) thickness of the slab sections 120a, 120b of the rib optical waveguide structure 110 (e.g., D3<D4). The lesser vertical (z-direction) thickness of the ridge section 118 and the lesser vertical (z-direction) thickness of the slab sections 120a, 120b of the rib optical waveguide structure 104 may increase the overlap between the optical mode of optical signals that propagate through the optical modulator structure 304 and the p-n junction of the optical modulator structure 304 corresponding to the junction between the doped regions 306 and 308 in the ridge section 118.

The increased overlap increases modulation efficiency of the optical modulator structure 304 in that the optical modes of optical signals overlap with a depletion area at the p-n junction, which modifies the refractive index of the ridge section 118 (and thus, the optical signals propagating through the ridge section 118).

Metal silicide layers 318 and 320 may be included on the terminal sections 122a and 122b, respectively, of the rib optical waveguide structure 104. The metal silicide layers 318 and 320 may each include a titanium silicide (TiSi), a ruthenium silicide (RuSi), a nickel silicide (NiSi), a cobalt silicide (CoSi), and/or another type of metal silicide material. The metal silicide layers 318 and 320 provide a transition between the semiconductor material of the rib optical waveguide structure 104 and the contact structures 322 and 324 that are respectively formed on the terminal sections 122a and 122b of the rib optical waveguide structure 104. The metal silicide layers 318 and 320 enable a low contact resistance to be achieved between the contact structures 322 and 324 and the terminal sections 122a and 122b of the rib optical waveguide structure 104.

In some implementations, the contact structures 322 and 324 may each include one or more electrically conductive materials, such as tungsten (W), cobalt (Co), ruthenium (Ru), titanium (Ti), aluminum (Al), copper (Cu), and/or gold (Au), among other examples of conductive materials. The contact structures 322 and 324 may each include a via, a contact plug, a trench, and/or another type of conductive structure.

The contact structures 322 and 324 may be electrically coupled and/or physically coupled with one or more metallization layers 326 in the dielectric region 128. The metallization layers 326 correspond to circuitry that enables signals and/or power to be provided to and/or from the optical modulator structure 304 and/or other devices in the semiconductor photonics device 300. The metallization layers 326 may each include one or more electrically conductive materials, such as tungsten (W), cobalt (Co), ruthenium (Ru), titanium (Ti), aluminum (Al), copper (Cu), and/or gold (Au), among other examples of conductive materials. The metallization layers 326 may each include vias, trenches, contact plugs, conductive pads, conductive pillars, and/or another type of metallization layers.

As indicated above, FIGS. 3A and 3B are provided as an example. Other examples may differ from what is described with regard to FIGS. 3A and 3B.

FIGS. 4A and 4B are diagrams of an example semiconductor photonics device 400 described herein. As shown in FIGS. 4A and 4B, the semiconductor photonics device 400 includes a photonic integrated circuit 402 that includes a similar combination and arrangement of layers and structures as the photonic integrated circuit 102 of the semiconductor photonics device 100. However, in the semiconductor photonics device 400, the rib optical waveguide structure 110 of the semiconductor photonics device 400 is included in a photodetector structure 404 of the photonic integrated circuit 402. The photodetector structure 404 may be configured to generate an electrical output (e.g., an electrical current, a voltage) based on optical signals received at the photodetector structure 404. The rib optical waveguide structure 104, the rib optical waveguide structure 106, and/or the strip optical waveguide structure 108 may be configured to provide optical signals to the photodetector structure 404.

The photodetector structure 404 may include an absorption region 406 that is included on the ridge section 118 of the rib optical waveguide structure 110. The absorption region 406 is configured to convert photons of received optical signals to electrons. The quantity of electrons generated may be based on the quantity of photons absorbed in the absorption region 406. Thus, the magnitude of the electrical output generated by the photodetector structure 404 may be based on the intensity of optical signals received at the photodetector structure 404. The electrons propagate through the slab sections 120a, 120b to the terminal sections 122a, 122b that correspond to collection regions for the electrons generated by the absorption region 406.

The absorption region 406 may include an epitaxially grown region of semiconductor material that includes germanium (Ge), germanium tin (GeSn), silicon germanium (SiGe), indium gallium arsenide (InGaAs), and/or gallium arsenide (GaAs), among other examples. Photons of optical signals received at the photodetector structure 404 interact with electron-hole pairs in the semiconductor material of the absorption region 406. The interaction causes electrons and electron holes to be separated and to migrate toward opposing terminal sections 122a, 122b (e.g., opposing collection regions), resulting in the generation of an electric field (e.g., a built-in electric field).

Regions of the rib optical waveguide structure 110 may be doped to promote the flow of electrons and/or electron holes between the absorption region 406 in the ridge section 118 and the terminal sections 122a, 122b through the slab sections 120a, 120b. For example, a doped region 408 may be included in the ridge section 118 and in the slab section 120a and in the terminal section 122a, and a doped region 410 may be included in the ridge section 118 and in the slab section 120b. As another example, a doped region 412 may be included in the slab section 120a and in the terminal section 122a, and a doped region 414 may be included in the slab section 120b and in the terminal section 122b. As another example, a doped region 416 may be included in the terminal section 122a, and a doped region 418 may be included in the terminal section 122b. The doped region 412 may have a greater dopant concentration than the dopant concentration of the doped region 408, and the doped region 416 may have a greater dopant concentration than the dopant concentration of the doped region 412. The doped region 414 may have a greater dopant concentration than the dopant concentration of the doped region 410, and the doped region 418 may have a greater dopant concentration than the dopant concentration of the doped region 414.

As described above in connection with FIG. 1B, the ridge section 118 of the rib optical waveguide structure 110 may have a greater vertical (z-direction) thickness than the vertical (z-direction) thickness of the ridge sections 118 of the rib optical waveguide structure 104 (e.g., D1>D2). Moreover, the slab sections 120a, 120b of the rib optical waveguide structure 110 may have a greater vertical (z-direction) thickness than the vertical (z-direction) thickness of the slab sections 120a, 120b of the rib optical waveguide structure 104 (e.g., D4>D3). The greater vertical (z-direction) thickness of the ridge section 118 of the rib optical waveguide structure 104 may provide a greater area in the ridge section 118 for formation of the absorption region 406. The greater size of the absorption region 406 may increase the full well capacity, and thus the sensitivity and range, of the photodetector structure.

The greater vertical (z-direction) thickness of the slab sections 120a, 120b of the rib optical waveguide structure 104 may provide a greater area in the slab sections 120a, 120b for electrons and electron holes flow from the absorption region 406 to the terminal sections 122a, 122b through the slab sections 120a, 120b. This may enable a low electrical resistance to be achieved between the absorption region 406 and the terminal sections 122a, 122b, which may increase the efficiency of the photodetector structure.

Metal silicide layers 420 and 422 may be included on the terminal sections 122a and 122b of the rib optical waveguide structure 110, respectively. The metal silicide layers 420 and 422 may each include a titanium silicide (TiSi), a ruthenium silicide (RuSi), and/or another type of metal silicide material. The metal silicide layers 420 and 422 provide a transition between the semiconductor material of the rib optical waveguide structure 110 and contact structures 424 and 426 that are respectively formed on the terminal sections 122a and 122b of the rib optical waveguide structure 110. The metal silicide layers 420 and 422 enable a low contact resistance to be achieved between the contact structures 424 and 426 and the terminal sections 122a and 122b of the rib optical waveguide structure 110.

In some implementations, the contact structures 424 and 426 may each include one or more electrically conductive materials, such as tungsten (W), cobalt (Co), ruthenium (Ru), titanium (Ti), aluminum (Al), copper (Cu), and/or gold (Au), among other examples of conductive materials. The contact structures 424 and 426 may each include a via, a contact plug, a trench, and/or another type of conductive structure.

The contact structures 424 and 426 may be electrically coupled and/or physically coupled with one or more metallization layers 428 in the dielectric region 128. The metallization layers 428 correspond to circuitry that enables signals and/or power to be provided to and/or from the photodetector structure 404 and/or other devices in the semiconductor photonics device 400. The metallization layers 428 may each include one or more electrically conductive materials, such as tungsten (W), cobalt (Co), ruthenium (Ru), titanium (Ti), aluminum (Al), copper (Cu), and/or gold (Au), among other examples of conductive materials. The metallization layers 428 may each include vias, trenches, contact plugs, conductive pads, conductive pillars, and/or another type of metallization layers.

As indicated above, FIGS. 4A and 4B are provided as an example. Other examples may differ from what is described with regard to FIGS. 4A and 4B. In other implementations, the rib optical waveguide structure 110 may be implemented as a phase shifter, an optical modulator structure, and/or another photonic component.

FIGS. 5A and 5B are diagrams of an example semiconductor photonics device 500 described herein. As shown in FIGS. 5A and 5B, the semiconductor photonics device 500 includes a photonic integrated circuit 502 that includes a similar combination and arrangement of layers and structures as the photonic integrated circuit 102 of the semiconductor photonics device 100. However, in the semiconductor photonics device 500, the rib optical waveguide structure 104 is included in an optical modulator structure 304, and the rib optical waveguide structure 110 is included in a photodetector structure 404 of the photonic integrated circuit 502.

The rib optical waveguide structure 106 and/or the strip optical waveguide structure 108 may be configured to provide optical signals between the optical modulator structure 304 and the photodetector structure 404. The optical modulator structure 304 and the photodetector structure 404 may be included in the semiconductor photonics device 500 to facilitate optical communication (e.g., intra-die optical communication) between regions of the semiconductor photonics device 500. In some implementations, additional optical waveguide structures and/or other photonics components are included in the semiconductor photonics device 500.

As indicated above, FIGS. 5A and 5B are provided as an example. Other examples may differ from what is described with regard to FIGS. 5A and 5B.

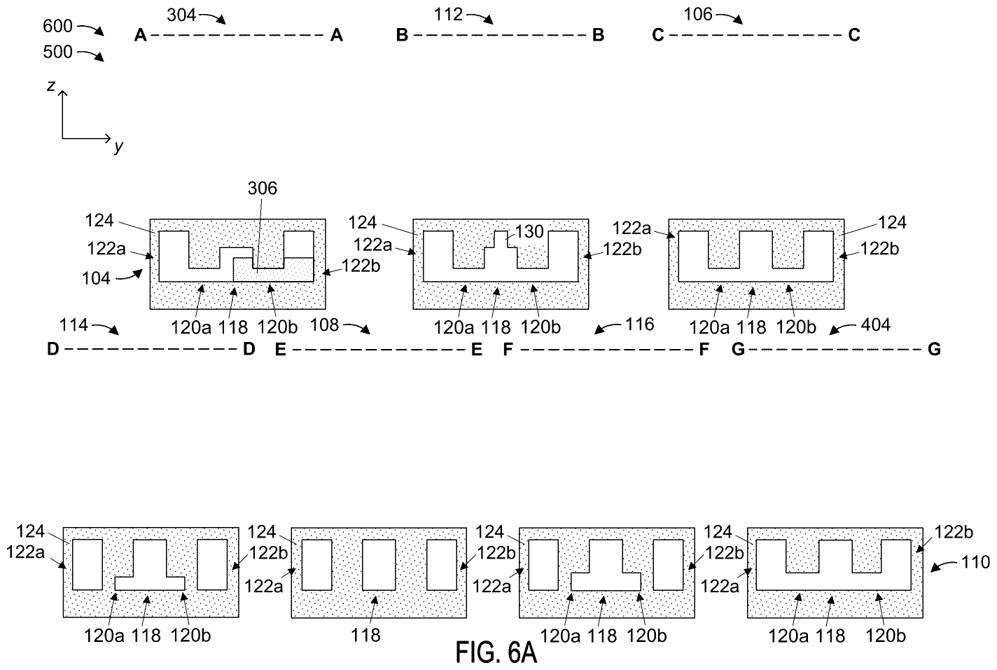

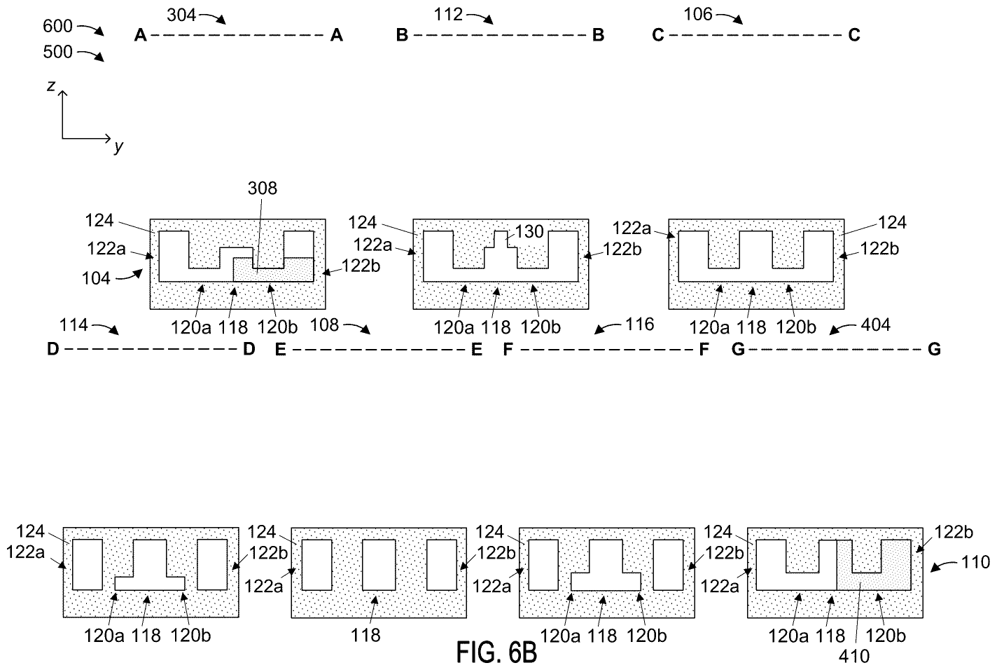

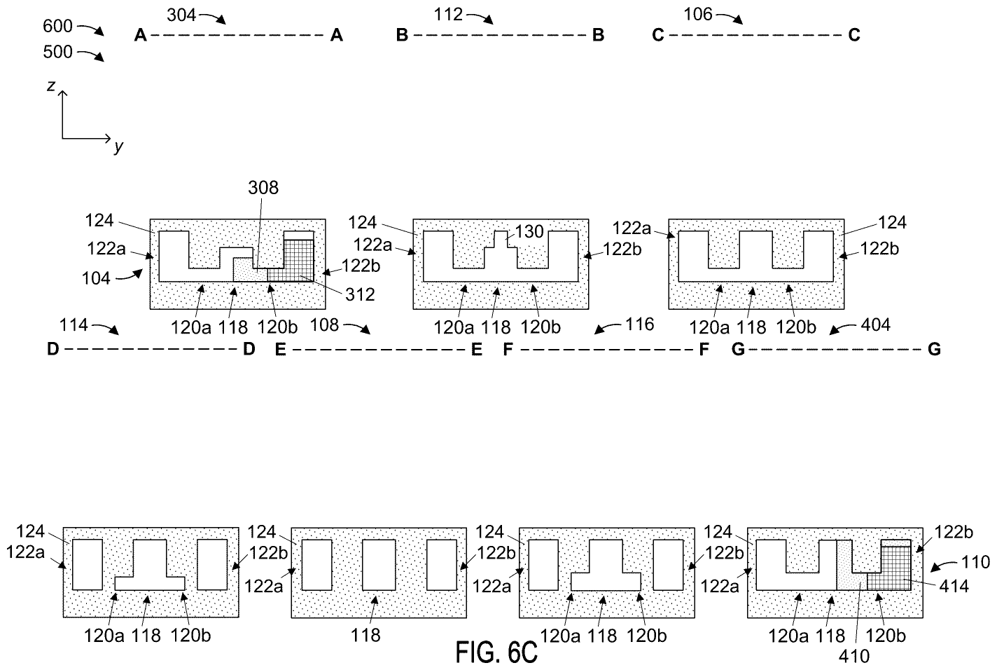

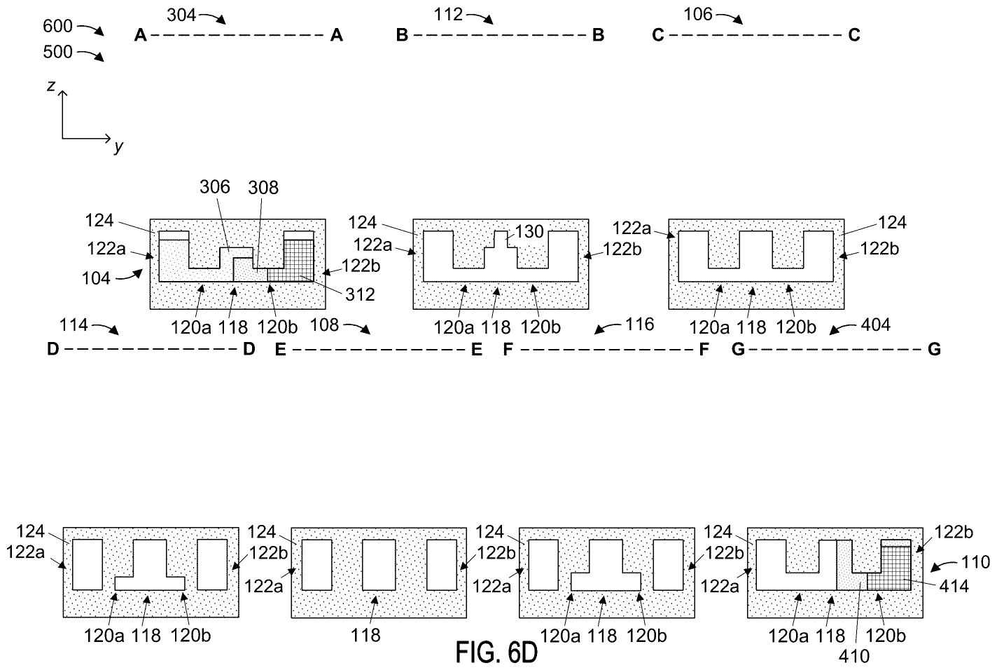

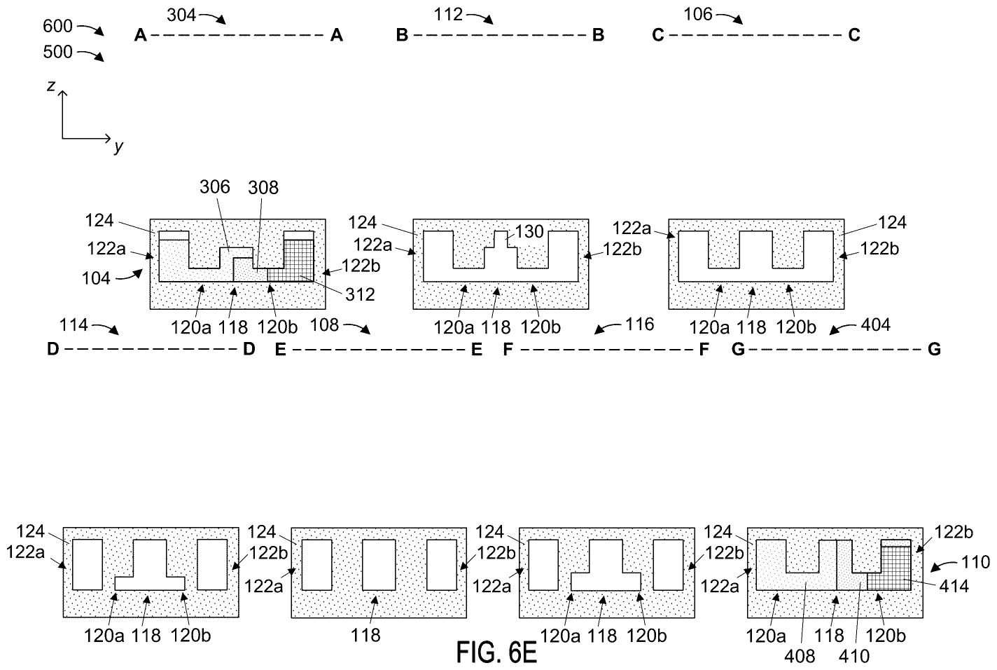

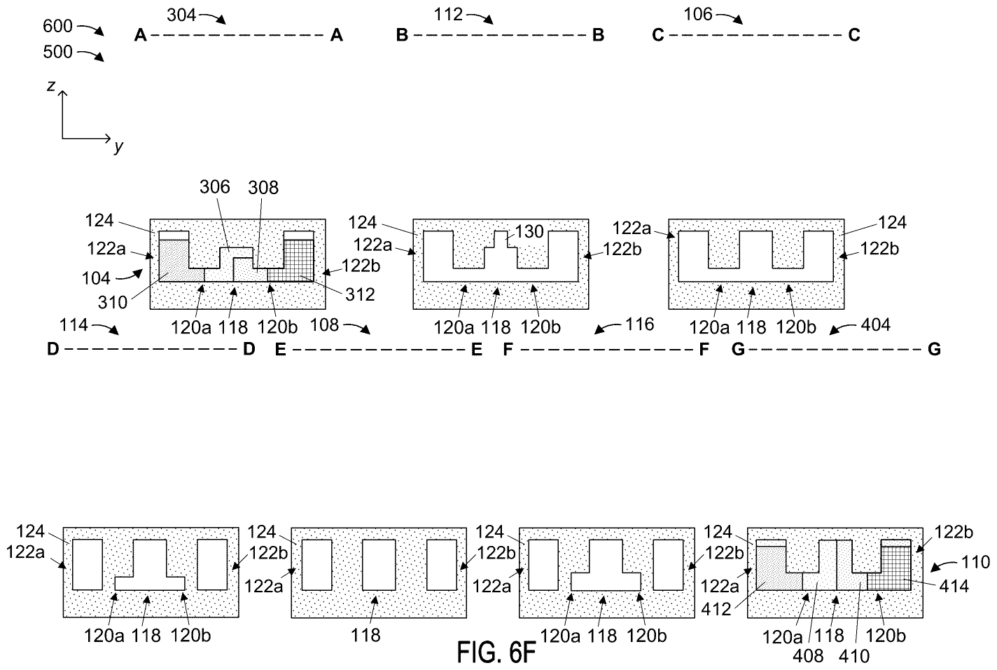

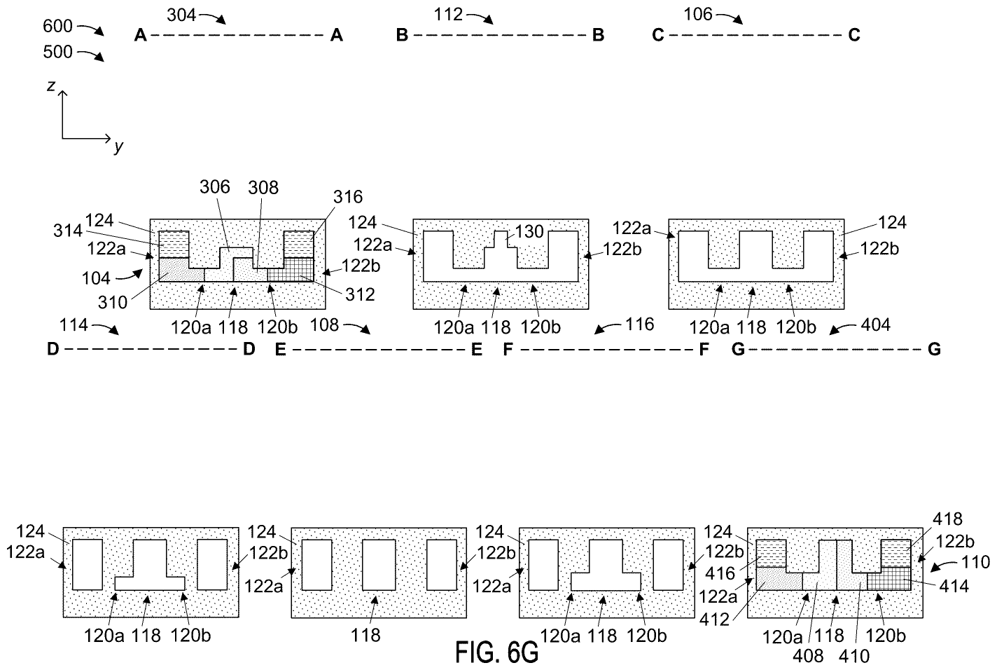

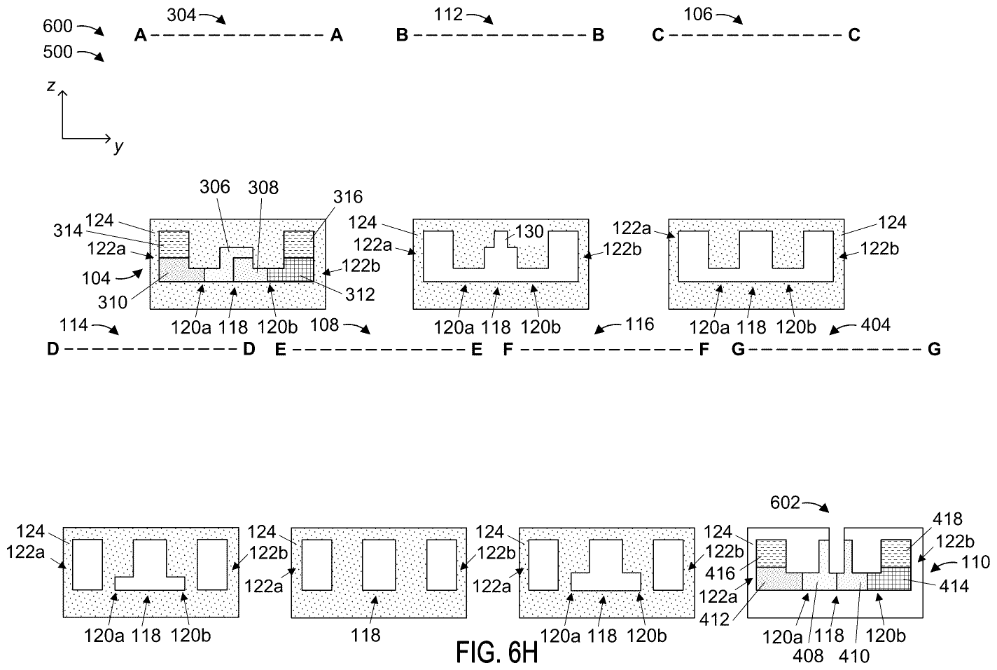

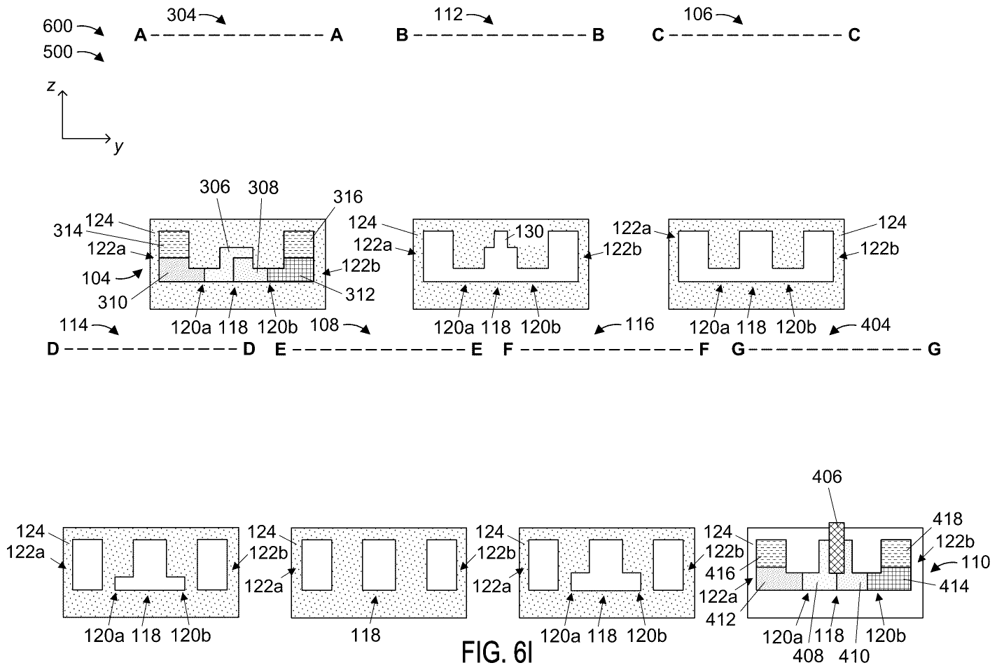

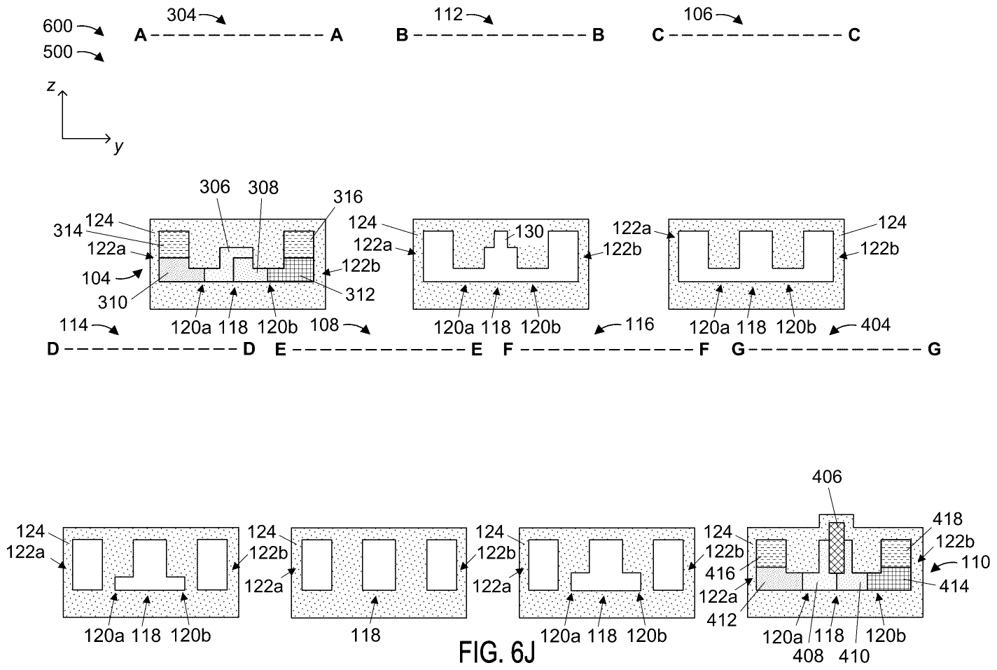

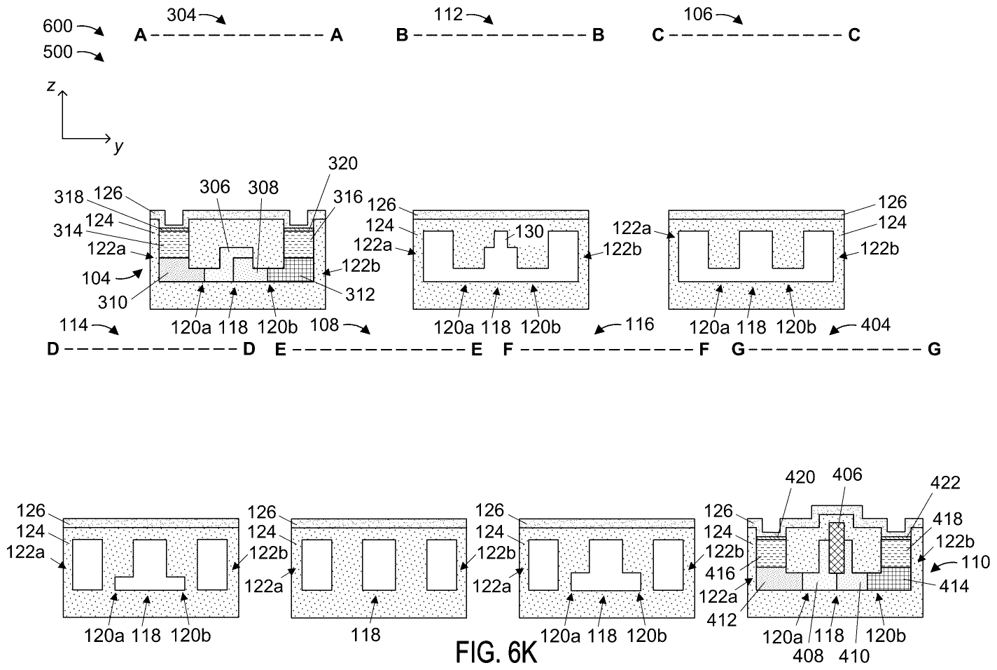

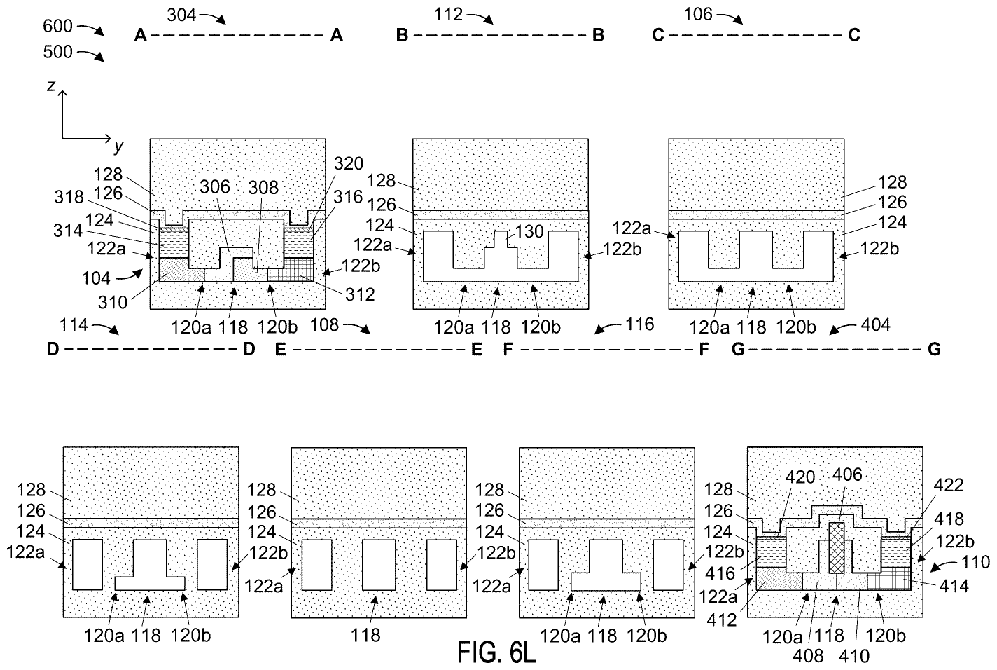

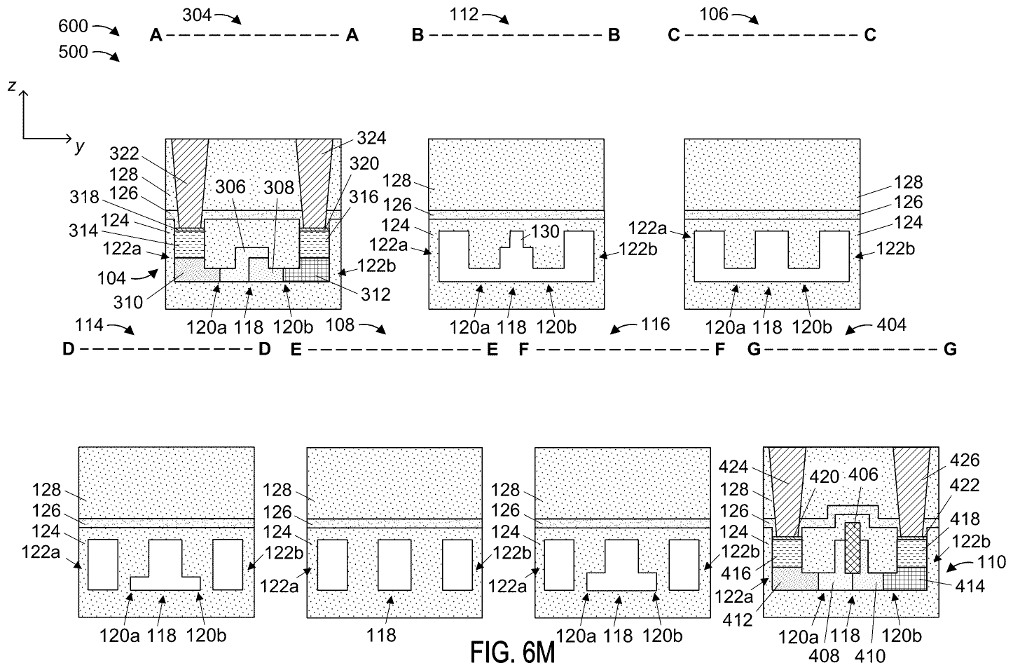

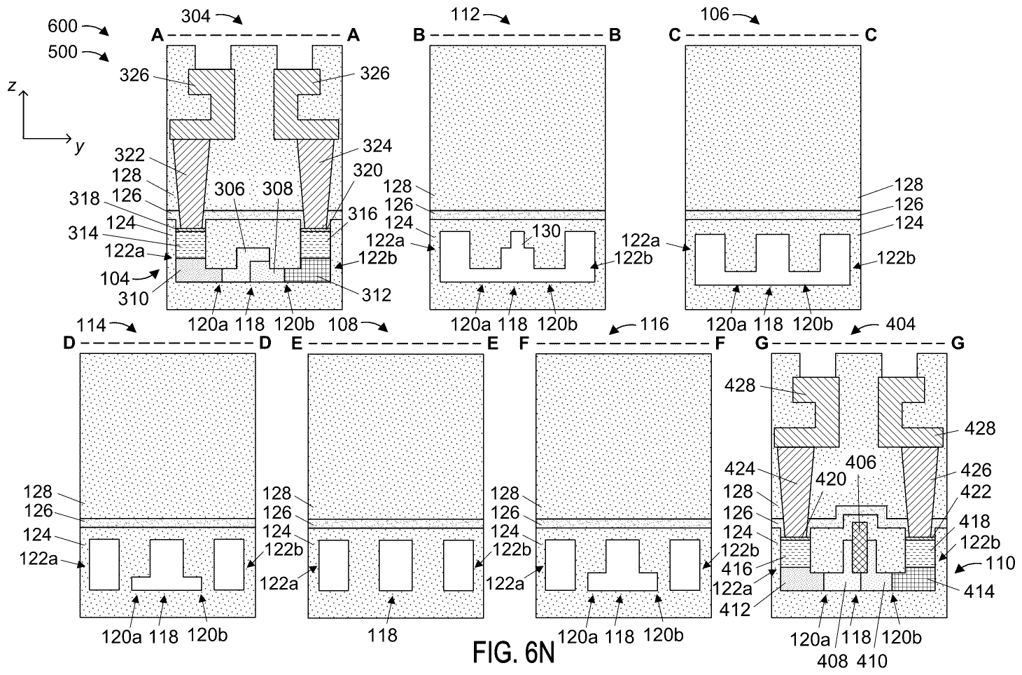

FIGS. 6A-6N are diagrams of an example implementation 600 of forming the semiconductor photonics device 500 described herein. In some implementations, one or more of the operations described in connection with FIGS. 6A-6N may be performed to form another semiconductor photonics device described herein, such as the semiconductor photonics device 100, the semiconductor photonics device 300, and/or the semiconductor photonics device 400, among other examples. In some implementations, one or more of the operations described in connection with FIGS. 6A-6N may be performed using one or more semiconductor processing tools, such as a deposition tool, an exposure tool, a developer tool, an etch tool, a planarization tool, an ion implantation tool, an annealing tool, and/or a wafer/die transport tool, among other examples.

As shown in FIG. 6A, one or more of the operations described in connection with FIGS. 2A-2Q may be performed to form the rib optical waveguide structure 104, the rib optical waveguide structure 106, the strip optical waveguide structure 108, the rib optical waveguide structure 110, and the associated transition regions 112, 114, and 116.

As shown in FIG. 6B, a portion of the rib optical waveguide structure 104 of the optical modulator structure 304 may be doped to form a doped region 308. Additionally and/or alternatively, a portion of the rib optical waveguide structure 110 of the photodetector structure 404 may be doped to form a doped region 410. In some implementations, the doped regions 308 and 410 may be doped with n-type dopants. In some implementations, the doped regions 308 and 410 may be doped with another type of dopant such as a p-type dopant.

In some implementations, an ion implantation tool is used to implant ions into the rib optical waveguide structures 104 and 110 to form the doped regions 308 and 410, respectively. In these implementations, dopant ions (e.g., n-type ions, p-type ions) may be accelerated toward the rib optical waveguide structures 104 and 110 and implanted into the rib optical waveguide structures 104 and 110 to form the doped regions 308 and 410, respectively. In some implementations, the doped region 308 and/or 410 is formed using another dopant technique such as diffusion.

In some implementations, an implant mask may be formed on the semiconductor photonics device 500 and patterned to facilitate doping of particular portions of the rib optical waveguide structures 104 and 110. For example, the implant mask may be used to dope a portion of the ridge sections 118 of the rib optical waveguide structures 104 and 110. As another example, the implant mask may be used to dope the slab sections 120b of the rib optical waveguide structures 104 and 110. As another example, the implant mask may be used to dope at least a portion of the terminal sections 122b of the rib optical waveguide structures 104 and 110.

As shown in FIG. 6C, another portion of the rib optical waveguide structure 104 of the optical modulator structure 304 may be doped to form a doped region 312. Additionally and/or alternatively, another portion of the rib optical waveguide structure 110 of the photodetector structure 404 may be doped to form a doped region 414. In some implementations, the doped regions 312 and 414 may be doped with the same dopant type as the doped regions 308 and 410. For example, the doped regions 312 and 414 may each be doped with n-type dopants, similar to the doped regions 308 and 410. Alternatively, the doped regions 312 and 414 may be doped with another type of dopant such as a p-type dopant. The dopant concentration of the doped region 312 may be greater than the dopant concentration of the doped region 308, and/or the dopant concentration of the doped region 414 may be greater than the dopant concentration of the doped region 410.

In some implementations, an ion implantation tool is used to implant ions into the rib optical waveguide structures 104 and 110 to form the doped regions 312 and 414, respectively. In these implementations, dopant ions (e.g., n-type ions, p-type ions) may be accelerated toward the rib optical waveguide structures 104 and 110 and implanted into the rib optical waveguide structures 104 and 110 to form the doped regions 312 and 414, respectively. In some implementations, the doped region 312 and/or 414 may be formed using another dopant technique such as diffusion.

In some implementations, an implant mask may be formed on the semiconductor photonics device 500 and patterned to facilitate doping of particular portions of the rib optical waveguide structures 104 and 110. For example, the implant mask may be used to dope a portion of the slab sections 120b and a portion of the terminal sections 122b of the rib optical waveguide structures 104 and 110. In some implementations, an annealing tool is used to perform an annealing operation prior to, during, and/or after implantation of the dopants into the doped regions 312 and 414.

As shown in FIG. 6D, another portion of the rib optical waveguide structure 104 of the optical modulator structure 304 may be doped to form a doped region 306. In some implementations, the doped region 306 may be doped with a different dopant type than the doped regions 308 and 312. For example, the doped region 306 may be doped with p-type dopants, whereas the doped regions 308 and 312 may be doped with n-type dopants. As another example, the doped region 306 may be doped with n-type dopants, whereas the doped regions 308 and 312 may be doped with p-type dopants.

In some implementations, an ion implantation tool is used to implant ions into the rib optical waveguide structures 104 to form the doped region 306. In these implementations, dopant ions (e.g., n-type ions, p-type ions) may be accelerated toward the rib optical waveguide structure 104 and implanted into the rib optical waveguide structure 104 to form the doped region 306. In some implementations, the doped region 306 may be formed using another dopant technique such as diffusion.

In some implementations, an implant mask may be formed on the semiconductor photonics device 500 and patterned to facilitate doping of particular portions of the rib optical waveguide structure 104. For example, the implant mask may be used to dope a portion of the ridge section 118 of the rib optical waveguide structure 104. As another example, the implant mask may be used to dope the slab section 120a of the rib optical waveguide structure 104. As another example, the implant mask may be used to dope at least a portion of the terminal section 122a of the rib optical waveguide structure 104.

As shown in FIG. 6E, another portion of the rib optical waveguide structure 110 of the photodetector structure 404 may be doped to form a doped region 408. In some implementations, the doped region 408 may be doped with a different dopant type than the doped regions 410 and 414. For example, the doped region 408 may be doped with p-type dopants, whereas the doped regions 410 and 414 may be doped with n-type dopants. As another example, the doped region 408 may be doped with n-type dopants, whereas the doped regions 410 and 414 may be doped with p-type dopants.

In some implementations, an ion implantation tool is used to implant ions into the rib optical waveguide structures 110 to form the doped region 408. In these implementations, dopant ions (e.g., n-type ions, p-type ions) may be accelerated toward the rib optical waveguide structure 110 and implanted into the rib optical waveguide structure 110 to form the doped region 408. In some implementations, the doped region 408 may be formed using another dopant technique such as diffusion.

In some implementations, an implant mask may be formed on the semiconductor photonics device 500 and patterned to facilitate doping of particular portions of the rib optical waveguide structure 110. For example, the implant mask may be used to dope a portion of the ridge section 118 of the rib optical waveguide structure 110. As another example, the implant mask may be used to dope the slab section 120a of the rib optical waveguide structure 110. As another example, the implant mask may be used to dope at least a portion of the terminal section 122a of the rib optical waveguide structure 110.

As shown in FIG. 6F, another portion of the rib optical waveguide structure 104 of the optical modulator structure 304 may be doped to form a doped region 310. Additionally and/or alternatively, another portion of the rib optical waveguide structure 110 of the photodetector structure 404 may be doped to form a doped region 412. In some implementations, the doped regions 310 and 412 may be doped with the same dopant type as the doped regions 306 and 408. For example, the doped regions 310 and 412 may each be doped with p-type dopants, similar to the doped regions 306 and 408. Alternatively, the doped regions 310 and 412 may be doped with another type of dopant such as an n-type dopant. The dopant concentration of the doped region 310 may be greater than the dopant concentration of the doped region 306, and/or the dopant concentration of the doped region 412 may be greater than the dopant concentration of the doped region 408.

In some implementations, an ion implantation tool is used to implant ions into the rib optical waveguide structures 104 and 110 to form the doped regions 310 and 412, respectively. In these implementations, dopant ions (e.g., n-type ions, p-type ions) may be accelerated toward the rib optical waveguide structures 104 and 110 and implanted into the rib optical waveguide structures 104 and 110 to form the doped regions 310 and 412, respectively. In some implementations, the doped region 310 and/or 412 may be formed using another dopant technique such as diffusion.

In some implementations, an implant mask may be formed on the semiconductor photonics device 500 and patterned to facilitate doping of particular portions of the rib optical waveguide structures 104 and 110. For example, the implant mask may be used to dope a portion of the slab sections 120a and a portion of the terminal sections 122a of the rib optical waveguide structures 104 and 110. In some implementations, an annealing tool is used to perform an annealing operation prior to, during, and/or after implantation of the dopants into the doped regions 310 and 412.

As shown in FIG. 6G, another portion of the rib optical waveguide structure 104 of the optical modulator structure 304 may be doped to form a doped region 316. Additionally and/or alternatively, another portion of the rib optical waveguide structure 110 of the photodetector structure 404 may be doped to form a doped region 418. In some implementations, the doped regions 316 and 418 may be doped with the same dopant type as the doped regions 308, 312, 410, and 414. For example, the doped regions 316 and 418 may each be doped with n-type dopants, similar to the doped regions 308, 312, 410, and 414. Alternatively, the doped regions 316 and 418 may be doped with another type of dopant such as a p-type dopant. The dopant concentration of the doped region 316 may be greater than the dopant concentrations of the doped regions 308 and 312, and/or the dopant concentration of the doped region 418 may be greater than the dopant concentrations of the doped regions 410 and 414.

In some implementations, an ion implantation tool is used to implant ions into the rib optical waveguide structures 104 and 110 to form the doped regions 316 and 418, respectively. In these implementations, dopant ions (e.g., n-type ions, p-type ions) may be accelerated toward the rib optical waveguide structures 104 and 110 and implanted into the rib optical waveguide structures 104 and 110 to form the doped regions 316 and 418, respectively. In some implementations, the doped region 316 and/or 418 may be formed using another dopant technique such as diffusion.

In some implementations, an implant mask may be formed on the semiconductor photonics device 500 and patterned to facilitate doping of particular portions of the rib optical waveguide structures 104 and 110. For example, the implant mask may be used to dope a portion of the terminal sections 122b of the rib optical waveguide structures 104 and 110. In some implementations, an annealing tool is used to perform an annealing operation prior to, during, and/or after implantation of the dopants into the doped regions 316 and 418.

As further shown in FIG. 6G, another portion of the rib optical waveguide structure 104 of the optical modulator structure 304 may be doped to form a doped region 314. Additionally and/or alternatively, another portion of the rib optical waveguide structure 110 of the photodetector structure 404 may be doped to form a doped region 416. In some implementations, the doped regions 314 and 416 may be doped with the same dopant type as the doped regions 306, 310, 408, and 412. For example, the doped regions 314 and 416 may each be doped with p-type dopants, similar to the doped regions 306, 310, 408, and 412. Alternatively, the doped regions 314 and 416 may be doped with another type of dopant such as an n-type dopant. The dopant concentration of the doped region 314 may be greater than the dopant concentrations of the doped regions 306 and 310, and/or the dopant concentration of the doped region 416 may be greater than the dopant concentrations of the doped regions 408 and 412.

In some implementations, an ion implantation tool is used to implant ions into the rib optical waveguide structures 104 and 110 to form the doped regions 314 and 416, respectively. In these implementations, dopant ions (e.g., n-type ions, p-type ions) may be accelerated toward the rib optical waveguide structures 104 and 110 and implanted into the rib optical waveguide structures 104 and 110 to form the doped regions 314 and 418, respectively. In some implementations, the doped region 314 and/or 416 may be formed using another dopant technique such as diffusion.

In some implementations, an implant mask may be formed on the semiconductor photonics device 500 and patterned to facilitate doping of particular portions of the rib optical waveguide structures 104 and 110. For example, the implant mask may be used to dope a portion of the terminal sections 122a of the rib optical waveguide structures 104 and 110. In some implementations, an annealing tool is used to perform an annealing operation prior to, during, and/or after implantation of the dopants into the doped regions 314 and 416.

As shown in FIG. 6H, a recess 602 may be formed in the ridge section 118 of the rib optical waveguide structure 110 of the photodetector structure 404. The recess 602 may be formed into a portion of the doped regions 408 and 410. In some implementations, a pattern in a photoresist layer is used to etch the ridge section 118 of the rib optical waveguide structure 110 to form the recess 602. In these implementations, a deposition tool may be used to form the photoresist layer on the semiconductor photonics device 500 (e.g., using a spin-coating technique and/or another suitable deposition technique). An exposure tool may be used to expose the photoresist layer to a radiation source to pattern the photoresist layer. A developer tool may be used to develop and remove portions of the photoresist layer to expose the pattern. An etch tool may be used to etch the ridge section 118 of the rib optical waveguide structure 110 based on the pattern to form the recess 602. In some implementations, the etch operation includes a dry etch operation (e.g., a plasma-based etch operation, a gas-based etch operation), a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for forming the recess 602 based on a pattern.

As shown in FIG. 6I, the recess 602 may be filled with an epitaxially-grown semiconductor material to form the absorption region 406 of the photodetector structure 404 in the recess 602. The epitaxially-grown semiconductor material may be a different material than the semiconductor material of the rib optical waveguide structure 110. For example, the epitaxially-grown semiconductor material may include germanium (Ge), whereas the semiconductor material of the rib optical waveguide structure 110 may include doped silicon (Si). A deposition tool may be used to epitaxially grow the semiconductor material of the absorption region 406 using an epitaxy technique. Additionally and/or alternatively, the absorption region 406 may be deposited using an ALD technique, a CVD technique, and/or another suitable deposition technique.

As shown in FIG. 6J, additional material of the dielectric region 124 may be formed over the semiconductor photonics device 500, including over the absorption region 406 of the photodetector structure 404. A deposition tool may be used to deposit the additional material of the dielectric region 124 using a PVD technique, an ALD technique, a CVD technique, an oxidation technique, and/or another suitable deposition technique.

As shown in FIG. 6K, the dielectric region 124 may be etched to expose the tops of the terminal sections 122a and 122b of the rib optical waveguide structure 104 of the optical modulator structure 304, and the metal silicide layers 318 and 320 may be respectively formed on the terminal sections 122a and 122b. Additionally and/or alternatively, the dielectric region 124 may be etched to expose the tops of the terminal sections 122a and 122b of the rib optical waveguide structure 110 of the photodetector structure 404, and the metal silicide layers 420 and 422 may be respectively formed on the terminal sections 122a and 122b.

Forming the metal silicide layers 318, 320, 420, and/or 422 may include depositing a layer of metal material (e.g., titanium (Ti), cobalt (Co), ruthenium (Ru), and/or nickel (Ni), among other examples) on the terminal sections 122a and 122b of the rib optical waveguide structures 104 and/or 110. A deposition tool may be used to deposit the metal material using a PVD technique, an ALD technique, a CVD technique, an electroplating technique, and/or another suitable deposition technique. An annealing tool may be used to perform an annealing operation to cause the metal material to diffuse into the terminal sections 122a and 122b of the rib optical waveguide structures 104 and/or 110 to form the metal silicide layers 318, 320, 420, and/or 422.

As further shown in FIG. 6K, the etch stop layer 126 may be formed on the dielectric region 124 and on the metal silicide layers 318, 320, 420, and/or 422. A deposition tool may be used to deposit the etch stop layer 126 using a PVD technique, an ALD technique, a CVD technique, and/or another suitable deposition technique.

As shown in FIG. 6L, a portion of the dielectric region 128 may be formed above the etch stop layer 126. A deposition tool may be used to deposit the portion of the dielectric region 128 using a PVD technique, an ALD technique, a CVD technique, and/or another suitable deposition technique. The portion of the dielectric region 128 may be formed in one or more deposition operations. In some implementations, a planarization tool is used to perform a planarization operation (e.g., a CMP operation) to planarize the portion of the dielectric region 128 after the portion of the dielectric region 128 is deposited.

As shown in FIG. 6M, contact structures 322 and 324 may be formed in and/or through the dielectric region 128. The contact structures 322 and 324 may extend through the etch stop layer 126 and may respectively land on the metal silicide layers 318 and 320. Additionally and/or alternatively, contact structures 424 and 426 may be formed in and/or through the dielectric region 128. The contact structures 424 and 426 may extend through the etch stop layer 126 and may respectively land on the metal silicide layers 420 and 422.

The contact structures 322, 324, 424, and/or 426 may be formed in recesses that extend through the dielectric region 128 and the etch stop layer 126. In some implementations, a pattern in a photoresist layer is used to etch the dielectric region 128 and the etch stop layer 126 to form the recesses. In these implementations, a deposition tool may be used to form the photoresist layer on the dielectric region 128 (e.g., using a spin-coating technique and/or another suitable deposition technique). An exposure tool may be used to expose the photoresist layer to a radiation source to pattern the photoresist layer. A developer tool may be used to develop and remove portions of the photoresist layer to expose the pattern. An etch tool may be used to etch the dielectric region 128 and the etch stop layer 126 based on the pattern to form the recesses. In some implementations, the etch operation includes a dry etch operation (e.g., a plasma-based etch operation, a gas-based etch operation), a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for forming the recesses based on a pattern.

A deposition tool may be used to deposit the contact structures 322, 324, 424, and/or 426 using a CVD technique, a PVD technique, an ALD technique, an electroplating technique, and/or another suitable deposition technique. The contact structures 322, 324, 424, and/or 426 may be deposited in one or more deposition operations. In some implementations, a seed layer is first deposited, and the contact structures 322, 324, 424, and/or 426 are deposited on the seed layer. In some implementations, a liner is first deposited, and the contact structures 322, 324, 424, and/or 426 are deposited on the liner. The liner may include an adhesion liner, a barrier liner, and/or another type of liner, and may include liner materials such as titanium nitride (TiN) and/or tantalum nitride (TaN), among other examples. In some implementations, a planarization tool is used to perform a planarization operation (e.g., a CMP operation) to planarize the contact structures 322, 324, 424, and/or 426 after the contact structures 322, 324, 424, and/or 426 are deposited.

As shown in FIG. 6N, another portion of the dielectric region 128 may be formed above the etch stop layer 126. A deposition tool may be used to deposit the other portion of the dielectric region 128 using a PVD technique, an ALD technique, a CVD technique, and/or another suitable deposition technique. The other portion of the dielectric region 128 may be formed in one or more deposition operations. In some implementations, a planarization tool is used to perform a planarization operation (e.g., a CMP operation) to planarize the other portion of the dielectric region 128 after the other portion of the dielectric region 128 is deposited.

As further shown in FIG. 6N, the metallization layers 326 and/or 428 may be formed in the dielectric region 128. Recesses may be formed in the dielectric region 128, and the metallization layers 326 and/or 428 may be formed in the recesses. One or more metallization layers 326 may be formed such that the one or more metallization layers 326 land on the contact structures 322 and/or 324 of the optical modulator structure 304. Additionally and/or alternatively, one or more metallization layers 428 may be formed such that the one or more metallization layers 428 land on the contact structures 424 and/or 426 of the photodetector structure 404.

In some implementations, a pattern in a photoresist layer is used to etch the dielectric region 128 to form the recesses. In these implementations, a deposition tool may be used to form the photoresist layer on the dielectric region 128 (e.g., using a spin-coating technique and/or another suitable deposition technique). An exposure tool may be used to expose the photoresist layer to a radiation source to pattern the photoresist layer. A developer tool may be used to develop and remove portions of the photoresist layer to expose the pattern. An etch tool may be used to etch the dielectric region 128 based on the pattern to form the recesses. In some implementations, the etch operation includes a dry etch operation (e.g., a plasma-based etch operation, a gas-based etch operation), a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for etching the dielectric region 128 based on a pattern.

A deposition tool may be used to deposit the metallization layers 326 and/or 428 using a CVD technique, a PVD technique, an ALD technique, an electroplating technique, and/or another suitable deposition technique. The metallization layers 326 and/or 428 may be deposited in one or more deposition operations. In some implementations, a seed layer is first deposited, and the metallization layers 326 and/or 428 are deposited on the seed layer. In some implementations, a planarization tool is used to perform a planarization operation (e.g., a CMP operation) to planarize the metallization layers 326 and/or 428 after the metallization layers 326 and/or 428 are deposited.

As indicated above, FIGS. 6A-6N are provided as an example. Other examples may differ from what is described with regard to FIGS. 6A-6N. For example, one or more of the operations described in connection with FIGS. 6A-6N may be performed to form only the optical modulator structure 304, such as in the semiconductor photonics device 300. As another example, one or more of the operations described in connection with FIGS. 6A-6N may be performed to form only the photodetector structure 404, such as in the semiconductor photonics device 400.

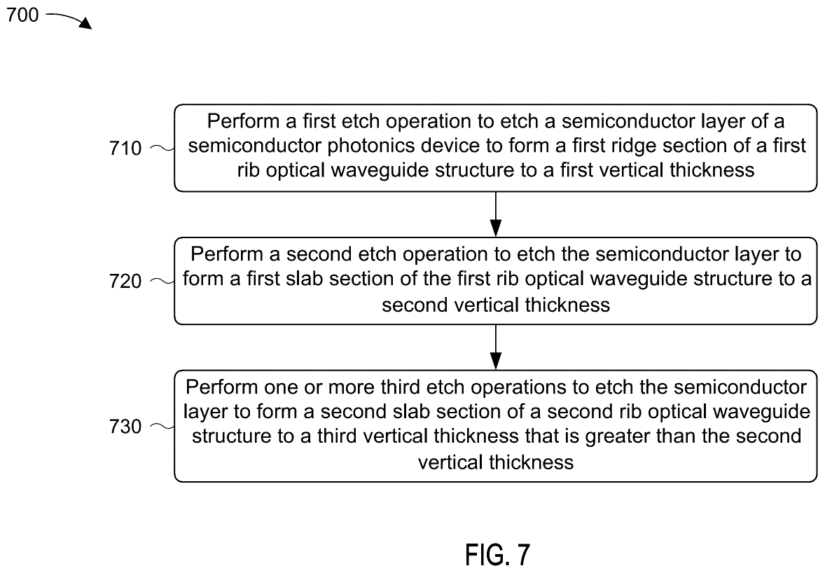

FIG. 7 is a flowchart of an example process 700 associated with forming a photonic integrated circuit of a semiconductor photonics device described herein. In some implementations, one or more process blocks of FIG. 7 are performed using one or more semiconductor processing tools, such as a deposition tool, an exposure tool, a developer tool, an etch tool, a planarization tool, an ion implantation tool, an annealing tool, a wafer/die transport tool, and/or another type of semiconductor processing tool.

As shown in FIG. 7, process 700 may include performing a first etch operation to etch a semiconductor layer of a semiconductor photonics device to form a first ridge section of a first rib optical waveguide structure to a first vertical thickness (block 710). For example, one or more semiconductor processing tools may be used to perform a first etch operation to etch a semiconductor layer (e.g., a semiconductor layer 206) of a semiconductor photonics device (e.g., a semiconductor photonics device 100, a semiconductor photonics device 300, a semiconductor photonics device 400, a semiconductor photonics device 500) to form a first ridge section (e.g., a ridge section 118) of a first rib optical waveguide structure (e.g., a rib optical waveguide structure 104) to a first vertical thickness (e.g., dimension D4), as described herein.

As further shown in FIG. 7, process 700 may include performing a second etch operation to etch the semiconductor layer to form a first slab section of the first rib optical waveguide structure to a second vertical thickness (block 720). For example, one or more semiconductor processing tools may be used to perform a second etch operation to etch the semiconductor layer to form a first slab section (e.g., a slab section 120a, a slab section 120b) of the first rib optical waveguide structure to a second vertical thickness (e.g., a dimension D3), as described herein.

As further shown in FIG. 7, process 700 may include performing one or more third etch operations to etch the semiconductor layer to form a second slab section of a second rib optical waveguide structure to a third vertical thickness that is greater than the second vertical thickness (block 730). For example, one or more semiconductor processing tools may be used to perform one or more third etch operations to etch the semiconductor layer to form a second slab section (e.g., a slab section 120a, a slab section 120b) of a second rib optical waveguide structure (e.g., a rib optical waveguide structure 110) to a third vertical thickness (e.g., a dimension D3) that is greater than the second vertical thickness, as described herein. In some implementations, the second rib optical waveguide structure comprises a second ridge section (e.g., a ridge section 118) that has a fourth vertical thickness (e.g., a dimension D1). In some implementations, the fourth vertical thickness is greater than the first vertical thickness.

Process 700 may include additional implementations, such as any single implementation or any combination of implementations described below and/or in connection with one or more other processes described elsewhere herein.

In a first implementation, performing the second etch operation comprises performing the second etch operation while a masking layer (e.g., a masking layer 214) covers the second rib optical waveguide structure.

In a second implementation, alone or in combination with the first implementation, the masking layer comprises a first masking layer, and process 700 includes forming the first masking layer, forming a second masking layer (e.g., a patterned masking layer 210) on the first masking layer, and patterning the first masking layer using the second masking layer, wherein performing the second etch operation comprises etching the semiconductor layer based on the pattern in the first masking layer to form the first slab section of the first rib optical waveguide structure to the second vertical thickness.

In a third implementation, alone or in combination with one or more of the first and second implementations, process 700 includes forming a third masking layer (e.g., a masking layer 212) on the semiconductor layer, where forming the first masking layer includes forming the first masking layer on the third masking layer.

In a fourth implementation, alone or in combination with one or more of the first through third implementations, performing the second etch operation includes performing the second etch operation while a masking layer (e.g., a masking layer 214) covers the first slab section of the first rib optical waveguide structure.

In a fifth implementation, alone or in combination with one or more of the first through fourth implementations, performing the first etch operation includes performing the first etch operation to etch the semiconductor layer to form the second slab section to the first vertical thickness, and performing the one or more third etch operations comprises performing the one or more third etch operations to etch the semiconductor layer to reduce a vertical thickness of the second slab section from the first vertical thickness to the third vertical thickness.

In a sixth implementation, alone or in combination with one or more of the first through fifth implementations, performing the one or more third etch operations includes performing a fourth etch operation to etch the semiconductor layer to form the second slab section to a fifth vertical thickness (e.g., a dimension D5), and performing a fifth etch operation to etch the semiconductor layer to reduce a vertical thickness of the second slab section from the fifth vertical thickness to the third vertical thickness.

In a seventh implementation, alone or in combination with one or more of the first through sixth implementations, process 700 includes performing the first etch operation, the second etch operation, and the one or more third etch operations to etch the semiconductor layer to form a strip optical waveguide structure (e.g., a strip optical waveguide structure 108).

In an eighth implementation, alone or in combination with one or more of the first through seventh implementations, process 700 includes performing the first etch operation and the second etch operation to etch the semiconductor layer to form a third rib optical waveguide structure (e.g., a rib optical waveguide structure 106), wherein the third rib optical waveguide structure includes a third slab section (e.g., a slab section 120a, a slab section 120b) having the second vertical thickness, and a third ridge section (e.g., a ridge section 118) having the fourth vertical thickness.

Although FIG. 7 shows example blocks of process 700, in some implementations, process 700 includes additional blocks, fewer blocks, different blocks, or differently arranged blocks than those depicted in FIG. 7. Additionally, or alternatively, two or more of the blocks of process 700 may be performed in parallel.

In this way, a plurality of optical waveguide structures are formed in a semiconductor layer of a semiconductor photonics device. The optical waveguide structures are formed in a manner in which different physical dimensions and/or configurations can be realized for the optical waveguide structures. For example, the operations described herein enable strip waveguide structures and rib waveguide structures to be formed from the same semiconductor layer and in the same process flow. Additionally and/or alternatively, the operations described herein enable rib waveguide structures having different slab thicknesses, different ridge thicknesses, and/or different combinations of slab thicknesses and ridge thicknesses to be formed from the same semiconductor layer and in the same process flow. This enables the functions performed by the optical waveguide structures to be optimized to achieve low insertion loss in the semiconductor photonics device, to achieve a high modulation efficiency in the semiconductor photonics device, and/or to achieve lower power consumption in the semiconductor photonics device, among other examples.

As described in greater detail above, some implementations described herein provide a semiconductor photonics device. The semiconductor photonics device includes a first rib optical waveguide structure. The first rib optical waveguide structure includes a first slab section and a first ridge section, where the first ridge section has a first vertical thickness. The semiconductor photonics device includes a second rib optical waveguide structure optically coupled to the first rib optical waveguide structure. The second rib optical waveguide structure includes a second slab section and a second ridge section, where the second ridge section has a second vertical thickness. The first vertical thickness and the second vertical thickness are different vertical thicknesses.

As described in greater detail above, some implementations described herein provide a method. The method includes performing a first etch operation to etch a semiconductor layer of a semiconductor photonics device to form a first ridge section of a first rib optical waveguide structure to a first vertical thickness. The method includes performing a second etch operation to etch the semiconductor layer to form a first slab section of the first rib optical waveguide structure to a second vertical thickness. The method includes performing one or more third etch operations to etch the semiconductor layer to form a second slab section of a second rib optical waveguide structure to a third vertical thickness that is greater than the second vertical thickness, where the second rib optical waveguide structure comprises a second ridge section that has a fourth vertical thickness, and where the fourth vertical thickness is greater than the first vertical thickness.

As described in greater detail above, some implementations described herein provide a semiconductor photonics device. The semiconductor photonics device includes a first rib optical waveguide structure. The first rib optical waveguide structure includes a first slab section and a first ridge section, where the first ridge section has a first vertical thickness. The semiconductor photonics device includes a second rib optical waveguide structure optically coupled to the first rib optical waveguide structure. Wherein the second rib optical waveguide structure includes a second slab section and a second ridge section, where the second ridge section has a second vertical thickness. The semiconductor photonics device includes a strip optical waveguide structure optically coupled to at least one of the first rib optical waveguide structure or the second rib optical waveguide structure. The strip waveguide structure has a third vertical thickness. The first vertical thickness is different from at least one of the second vertical thickness or the third vertical thickness.

The terms “approximately” and “substantially” can indicate a value of a given quantity that varies within 5% of the value (e.g., ±1%, ±2%, ±3%, ±4%, ±5% of the value). These values are merely examples and are not intended to be limiting. It is to be understood that the terms “approximately” and “substantially” can refer to a percentage of the values of a given quantity in light of this disclosure.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A semiconductor photonics device, comprising:
a first rib optical waveguide structure comprising a first slab section and a first ridge section,
wherein the first ridge section has a first vertical thickness; and
a second rib optical waveguide structure, optically coupled to the first rib optical waveguide structure, comprising a second slab section and a second ridge section,
wherein the second ridge section has a second vertical thickness, and
wherein the first vertical thickness and the second vertical thickness are different vertical thicknesses.

2. The semiconductor photonics device of claim 1, wherein the first slab section has a third vertical thickness;
wherein the second slab section has a fourth vertical thickness; and
wherein the third vertical thickness and the fourth vertical thickness are different vertical thicknesses.

3. The semiconductor photonics device of claim 2, wherein the first vertical thickness is less than the second vertical thickness; and
wherein the third vertical thickness is less than the fourth vertical thickness.

4. The semiconductor photonics device of claim 1, wherein the first slab section has a third vertical thickness;
wherein the second slab section has a fourth vertical thickness; and
wherein the third vertical thickness and the fourth vertical thickness are approximately a same vertical thickness.

5. The semiconductor photonics device of claim 4, wherein the first vertical thickness is less than the second vertical thickness.

6. The semiconductor photonics device of claim 3, further comprising:
a transition region located laterally between the first rib optical waveguide structure and the second rib optical waveguide structure,
wherein the transition region comprises:
a third slab section having the fourth vertical thickness;
a third ridge section having the first vertical thickness; and
a tapered transition section having the second vertical thickness.

7. A method, comprising:
performing a first etch operation to etch a semiconductor layer of a semiconductor photonics device to form a first ridge section of a first rib optical waveguide structure to a first vertical thickness;
performing a second etch operation to etch the semiconductor layer to form a first slab section of the first rib optical waveguide structure to a second vertical thickness; and
performing one or more third etch operations to etch the semiconductor layer to form a second slab section of a second rib optical waveguide structure to a third vertical thickness that is greater than the second vertical thickness,
wherein the second rib optical waveguide structure comprises a second ridge section that has a fourth vertical thickness, and
wherein the fourth vertical thickness is greater than the first vertical thickness.

8. The method of claim 7, wherein performing the second etch operation comprises:
performing the second etch operation while a masking layer covers the second rib optical waveguide structure.

9. The method of claim 8, wherein the masking layer comprises a first masking layer; and
wherein the method further comprises:
forming the first masking layer;
forming a second masking layer on the first masking layer; and
patterning the first masking layer using the second masking layer,
wherein performing the second etch operation comprises:
etching the semiconductor layer based on the pattern in the first masking layer to form the first slab section of the first rib optical waveguide structure to the second vertical thickness.

10. The method of claim 9, further comprising:
forming a third masking layer on the semiconductor layer,
wherein forming the first masking layer comprises:
forming the first masking layer on the third masking layer.

11. The method of claim 8, wherein performing the second etch operation comprises:
performing the second etch operation while a masking layer covers the first slab section of the first rib optical waveguide structure.

12. The method of claim 7, wherein performing the first etch operation comprises:
performing the first etch operation to etch the semiconductor layer to form the second slab section to the first vertical thickness; and
wherein performing the one or more third etch operations comprises:
performing the one or more third etch operations to etch the semiconductor layer to reduce a vertical thickness of the second slab section from the first vertical thickness to the third vertical thickness.

13. The method of claim 7, wherein performing the one or more third etch operations comprises:
performing a fourth etch operation to etch the semiconductor layer to form the second slab section to a fifth vertical thickness; and
performing a fifth etch operation to etch the semiconductor layer to reduce a vertical thickness of the second slab section from the fifth vertical thickness to the third vertical thickness.

14. The method of claim 7, further comprising:
performing the first etch operation, the second etch operation, and the one or more third etch operations to etch the semiconductor layer to form a strip optical waveguide structure.

15. The method of claim 7, further comprising:
performing the first etch operation and the second etch operation to etch the semiconductor layer to form a third rib optical waveguide structure,
wherein the third rib optical waveguide structure comprises:
a third slab section having the second vertical thickness, and
a third ridge section having the fourth vertical thickness.

16. A semiconductor photonics device, comprising:
a first rib optical waveguide structure comprising a first slab section and a first ridge section,
wherein the first ridge section has a first vertical thickness;
a second rib optical waveguide structure, optically coupled to the first rib optical waveguide structure, comprising a second slab section and a second ridge section,
wherein the second ridge section has a second vertical thickness; and
a strip optical waveguide structure optically coupled to at least one of the first rib optical waveguide structure or the second rib optical waveguide structure,
wherein the strip optical waveguide structure has a third vertical thickness, and
wherein the first vertical thickness is different from at least one of the second vertical thickness or the third vertical thickness.

17. The semiconductor photonics device of claim 16, further comprising:
a first transition region laterally between the first rib optical waveguide structure and the second rib optical waveguide structure; and
a second transition region laterally between the second rib optical waveguide structure and the strip optical waveguide structure.

18. The semiconductor photonics device of claim 17, wherein the first transition region comprises a fourth ridge section having a fourth vertical thickness;
wherein the second transition region comprises a fifth ridge section having a fifth vertical thickness; and
wherein the fourth vertical thickness and the fifth vertical thickness are different thicknesses.

19. The semiconductor photonics device of claim 16, wherein the first rib optical waveguide structure is included in an optical modulator structure of the semiconductor photonics device.

20. The semiconductor photonics device of claim 16, wherein the second rib optical waveguide structure is included in a photodetector structure of the semiconductor photonics device.
